(19) United States
(12) Patent Application Publication
(10) Pub. No.: US 2026/0200304 A1
(43) Pub. Date: Jul. 16, 2026

(54) UTILITY VEHICLE

(71) Applicant: Textron Inc., Providence, RI (US)

(72) Inventors: Deanna Theresa Houston, Evans, GA (US); John Thomas Wade Sidwell, Augusta, GA (US); Christian Antwi, Evans, GA (US); Oliver Daniel Newman, Martinez, GA (US); Lyla Shyann Valentin, Augusta, GA (US)

(73) Assignee: Textron Inc., Providence, RI (US)

(21) Appl. No.: 19/020,855

(22) Filed: Jan. 14, 2025

(51) Int. Cl. B60K 1/04; B60K 5/00; B60K 13/02; B60K 15/073; B60L 50/60; B60L 50/64; B60N 2/68; B60P 1/04; B60R 7/04; B62D 21/02; B62D 29/00; B62D 33/08

(52) U.S. Cl. CPC B60K 1/04; B60K 5/00; B60K 13/02; B60K 15/073; B60L 50/64; B60L 50/66; B60N 2/68; B60P 1/04; B60R 7/043; B62D 21/02; B62D 29/008; B62D 33/08

(57) ABSTRACT

A utility vehicle includes a tractive element coupled to a chassis, a prime mover configured to drive the tractive element, and a seat assembly supported by the chassis. The seat assembly includes a seat frame and a seat supported by the seat frame. The seat frame defines a storage compartment beneath the seat. A bed is positioned rearward of the seat and pivotable relative to the chassis between a first position and a second position. The utility vehicle includes at least one of (a) an actuator configured to move the bed between the first position and the second position or (b) a removable fastener configured to limit movement of the bed from the first position toward the second position. The bed is configured to support a load of at least about 1,200 pounds. The bed has a bed length extending at least about 6 feet along the longitudinal axis.

### BACKGROUND

Utility vehicles may be used to transport people, material, and equipment throughout a jobsite or work environment (e.g., a golf course, a festival, a farm, a university, a factory, a theme park, a warehouse, etc.). A utility vehicle may be equipped with one or more seats to support operators and passengers. A utility vehicle may include a bed to support material and equipment.

### SUMMARY

One embodiment relates to a utility vehicle. The utility vehicle includes a chassis defining a longitudinal axis, a tractive element coupled to the chassis, a prime mover configured to drive the tractive element to propel the utility vehicle, and a seat assembly supported by the chassis and configured to support an operator. The seat assembly includes a seat frame and a seat supported by the seat frame. The seat frame defines a storage compartment beneath the seat. The utility vehicle further includes a bed positioned rearward of the seat and pivotable relative to the chassis between a first position and a second position and at least one of (a) an actuator configured to move the bed between the first position and the second position or (b) a fastener removably coupled to the seat frame and configured to limit movement of the bed from the first position toward the second position. The bed is configured to support a load of at least about 1,200 pounds. The bed has a bed length extending at least about 6 feet along the longitudinal axis.

Another embodiment relates to a utility vehicle. The utility vehicle includes a chassis extending longitudinally, a tractive element coupled to the chassis, an electric motor configured to drive the tractive element to propel the utility vehicle, and a battery pack coupled to the chassis and positioned forward of the electric motor. The battery pack is configured to supply electrical energy to the electric motor. The battery pack includes a first battery module and a second battery module longitudinally offset from the first battery module. The utility vehicle further includes a seat assembly supported by the chassis. The seat assembly includes a seat frame and a seat supported by the seat frame. The seat frame defines a storage compartment beneath the seat. The seat includes a seat bottom that is repositionable to permit access to the storage compartment. The utility vehicle further includes a bed positioned rearward of the seat and coupled to the chassis. The bed is pivotable relative to the chassis. The battery pack and the electric motor are both positioned beneath the bed and rearward of the storage compartment. The bed is configured to support a load of at least about 1,200 pounds. The bed has a bed length extending longitudinally. The bed length is at least about 6 feet.

Still another embodiment relates to a utility vehicle. The utility vehicle includes a chassis including a first frame rail and a second frame rail extending longitudinally and laterally offset from one another, a splash plate fixedly coupled to the first frame rail and extending laterally away from the second frame rail, and a seat frame fixedly coupled to the first frame rail and the second frame rail and extending upward from the first frame rail. The utility vehicle further includes a tractive element coupled to the chassis, an engine coupled to the chassis and configured to drive the tractive element to propel the utility vehicle, a fuel tank coupled to the chassis and configured to supply fuel to the engine, the splash plate extending beneath the fuel tank, and a seat assembly supported by the chassis. The seat assembly includes a seat frame and a seat supported by the seat frame. The seat frame defines a storage compartment beneath the seat. The seat includes a seat bottom that is repositionable to permit access to the storage compartment. The utility vehicle further includes an air intake coupled to a rear side of the seat frame and configured to supply air to the engine, a carbon canister coupled to the rear side of the seat frame and configured to capture a contaminant released by the fuel tank, and a bed positioned rearward of the seat and coupled to the chassis. The bed is pivotable relative to the chassis between a first position and a second position. The engine and the fuel tank are positioned rearward of the storage compartment and below the bed. The bed is configured to support a load of at least about 1,200 pounds. The bed has a bed length extending longitudinally. The bed length is at least about 6 feet.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a top perspective view of a vehicle, according to an exemplary embodiment.

FIG. 5 is a side view of the vehicle of FIG. 4.

FIG. 6 is a front view of the vehicle of FIG. 4.

FIG. 7 is a bottom perspective view of the vehicle of FIG. 4 in an electrified configuration, according to an exemplary embodiment.

FIG. 8 is a bottom perspective view of the vehicle of FIG. 4 in an internal combustion configuration, according to an exemplary embodiment.

FIG. 9 is a top perspective view of a frame of the vehicle of FIG. 4, according to an exemplary embodiment.

FIG. 10 is a top perspective view of the frame of FIG. 9.

FIG. 11 is a bottom perspective view of the frame of FIG. 9.

FIG. 12 is a top view of the frame of FIG. 9.

FIGS. 13 and 14 are top perspective views of the frame of FIG. 9.

FIG. 15 is a top perspective view of a seat frame of the vehicle of FIG. 4, according to an exemplary embodiment.

FIG. 16 is a bottom perspective view of the seat frame of FIG. 15.

FIG. 17 is a top perspective view of the seat frame of FIG. 15.

FIG. 18 is a top perspective view of the vehicle of FIG. 4 in the internal combustion configuration.

FIG. 19 is a top perspective view of the vehicle of FIG. 4.

FIG. 20 is a bottom perspective view of the vehicle of FIG. 4 in the internal combustion configuration.

FIG. 21 is a bottom perspective view of the vehicle of FIG. 4 in the internal combustion configuration with a side panel removed.

FIG. 22 is a top perspective view of the vehicle of FIG. 4 in the internal combustion configuration with the side panel removed.

FIG. 23 is a side section view of the vehicle of FIG. 4 in the internal combustion configuration.

FIG. 24 is a front section view of the vehicle of FIG. 4 in the internal combustion configuration.

FIG. 25 is a top perspective view of the vehicle of FIG. 4 in the electrified configuration.

FIG. 26 is a top perspective view of the vehicle of FIG. 4 in the electrified configuration with a side panel removed.

FIG. 27 is a top perspective view of the vehicle of FIG. 4.

FIG. 28 is a top perspective view of the vehicle of FIG. 4 in the internal combustion configuration.

FIGS. 29 and 30 are top perspective views of the vehicle of FIG. 4.

FIG. 31 is a top perspective view of the vehicle of FIG. 4 in the internal combustion configuration.

FIG. 32 is a top perspective view of the vehicle of FIG. 4 in the electrified configuration with a side panel removed.

FIG. 33 is a front perspective view of a battery pack of the vehicle of FIG. 4, according to an exemplary embodiment.

FIG. 34 is a front perspective view of the battery pack of FIG. 33.

FIG. 35 is a rear perspective view of the battery pack of FIG. 33.

FIG. 36 is a bottom view of the battery pack of FIG. 33.

FIG. 37 is a bottom perspective view of a bed for a vehicle, according to an exemplary embodiment.

FIG. 38 is a side section view of a bed for a vehicle, according to an exemplary embodiment.

FIG. 39 is a bottom perspective view of a bed for a vehicle, according to an exemplary embodiment.

FIG. 40 is a top view of a bed for a vehicle, according to an exemplary embodiment.

FIG. 41 is a top view of a bed for a vehicle, according to an exemplary embodiment.

FIG. 42 is a top view of a bed for a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

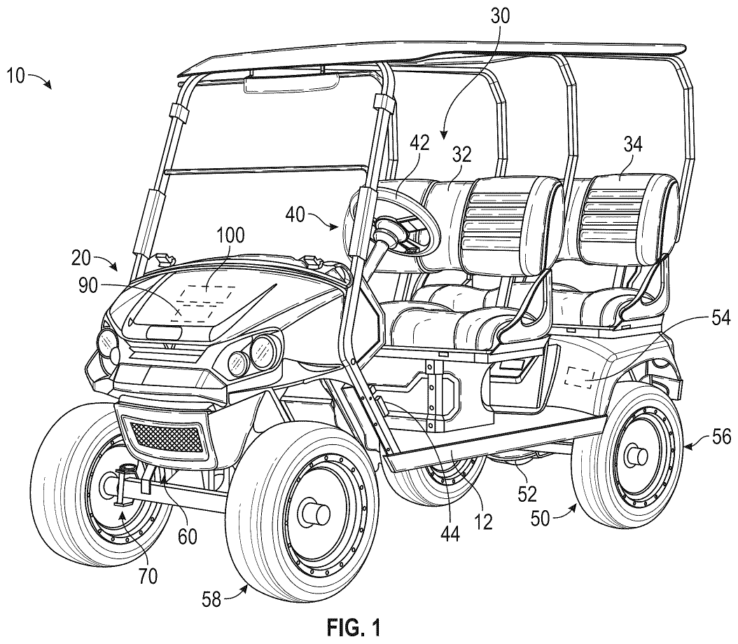

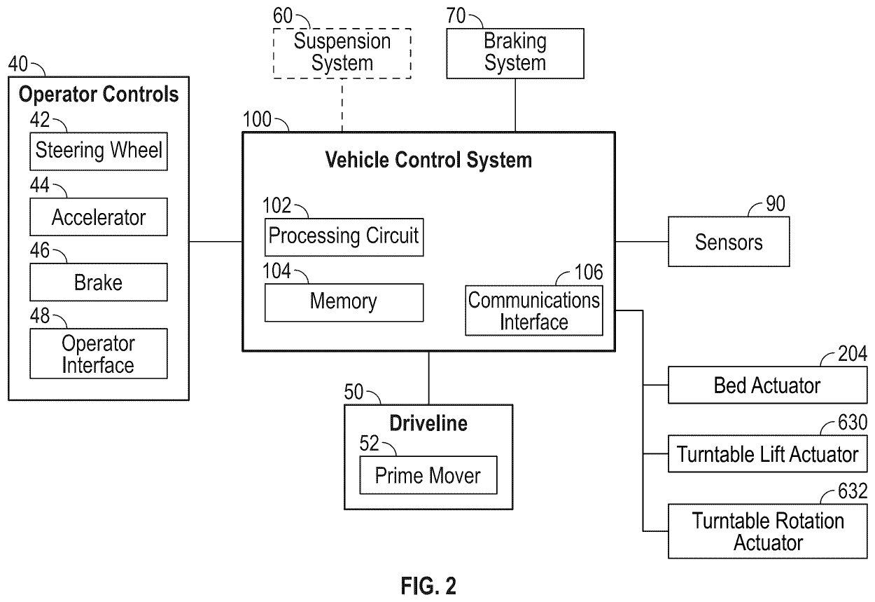

As shown in FIGS. 1 and 2, a machine or utility vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

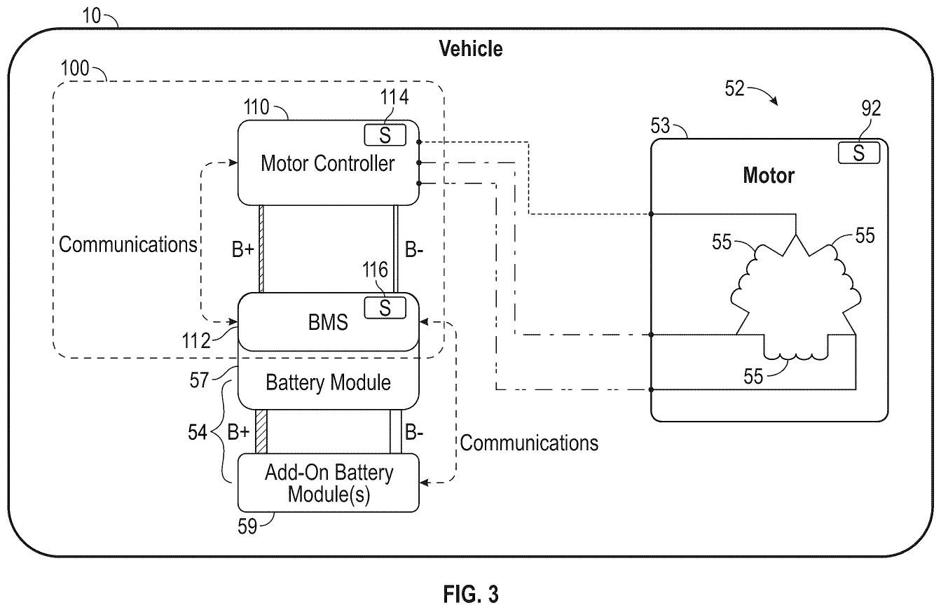

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., remote systems) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Utility Vehicle Configurations

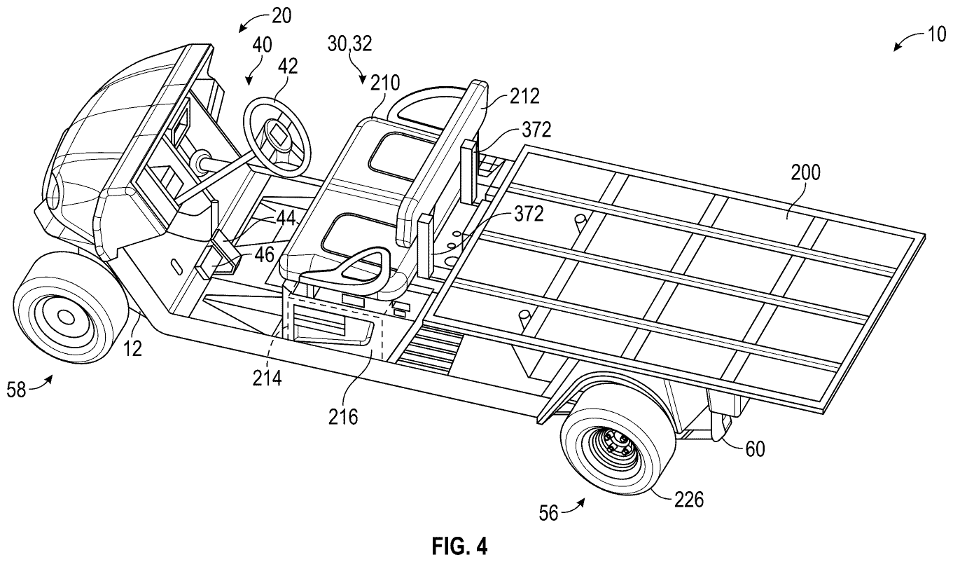

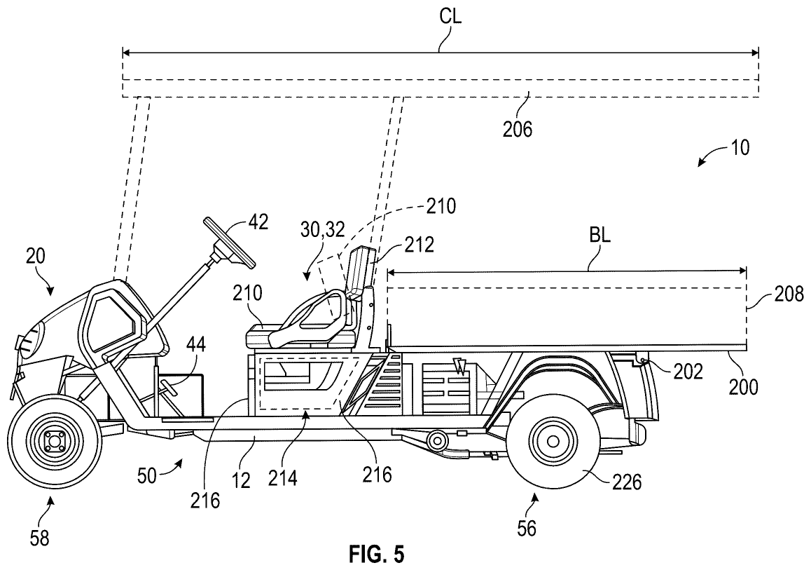

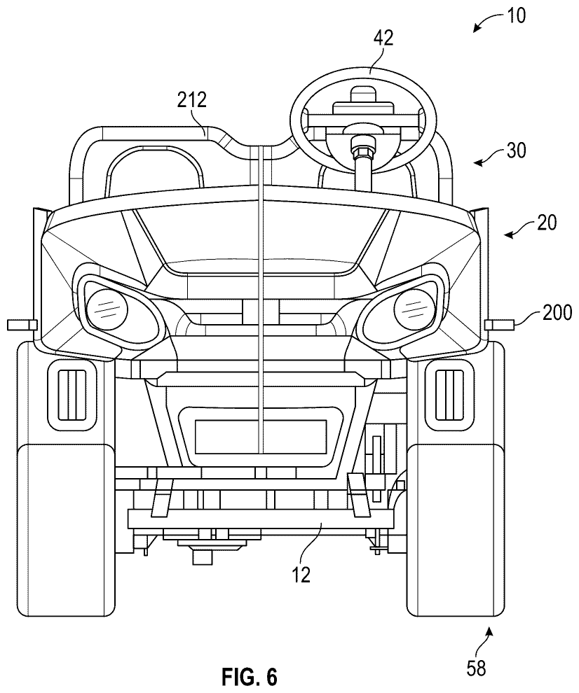

Referring to FIGS. 4-6, the vehicle 10 is shown configured as a hauler (e.g., a work machine, a dumper, a material or equipment transport vehicle, etc.). In the embodiment of FIG. 4-6, the occupant seating area 30 does not include the rear row seating 34. Instead, the vehicle 10 includes a bed (e.g., a flatbed, a truck bed, a cargo area, a load space, etc.), shown as bed 200. The bed 200 is positioned behind the front row seating 32 and extends rearward. As shown in FIG. 5, the bed 200 overhangs the body 20, such that the bed 200 extends rearward beyond the body 20.

As shown in FIG. 5, the bed 200 has a bed length BL measured longitudinally from a front end of the bed 200 to a rear end of the bed 200. In some embodiments, the bed length BL is at least about 6 feet (e.g., at least 65 inches, at least 72 inches, at least 79 inches, etc.). Beneficially, the bed length BL may be longer than the bed length of similarly sized vehicles, providing a greater storage area than the other vehicles. In some embodiments, the bed 200 is made from (e.g., constructed primarily from) aluminum. The bed 200 may include one or more components made entirely from aluminum.

While in use, the bed 200 may support and transport a load (e.g., a payload, cargo, etc.). The load may include one or more items (e.g., pieces of firewood, bags of mulch, golf bags, etc.). Additionally or alternatively, the load may include volume of material (e.g., dirt, sand, gravel, etc.). Beneficially, the arrangement of the frame 12 may increase the payload capacity of the vehicle 10 and permit the vehicle 10 to support greater loads than similarly sized vehicles. By way of example, the bed 200 may be able to support a load of at least about 1,200 pounds (e.g., at least 1,080 pounds, at least 1,200 pounds, at least 1,320 pounds, etc.). While supporting this load, the vehicle 10 may be capable of traveling at at least about 16.5 miles per hour.

The vehicle 10 may include one or more accessories that, when equipped to the vehicle 10, provide additional functionality. The accessories may be removable (e.g., when the functionality of the accessory is not desired or required). As shown in FIG. 5, the vehicle 10 includes an accessory, awning, or sunshade, shown as canopy 206. The canopy 206 extends longitudinally and above the rest of the vehicle 10, such that the front row seating 32 and the bed 200 extend beneath the canopy 206. The canopy 206 may provide shade and protection from weather (e.g., rain, snow, etc.) to occupants of the front row seating 32 and the load supported by the bed 200. As shown, the canopy 206 has a canopy length CL measured longitudinally from a front end of the canopy 206 to a rear end of the canopy 206. In some embodiments, the canopy length CL is about 116 inches to facilitate covering the front row seating 32 and the extended length of the bed 200.

As shown in FIG. 5, the vehicle 10 includes an accessory or enclosure, shown as bed box 208. The bed box 208 is coupled to the bed 200 and includes one or more walls extending upward from the bed 200. The walls may partially enclose a storage volume along a top of the bed 200. This partially enclosed storage volume may facilitate carrying items or material that could otherwise slide off of the bed 200.

As shown in FIG. 5, the bed 200 is pivotably coupled to the frame 12. Specifically, the bed 200 may be rotatable about a lateral axis of rotation, shown as axis of rotation 202. The axis of rotation 202 is positioned at a rear end of the frame 12. The bed 200 may be repositionable between a storage position, use position, or lowered position (e.g., as shown in FIG. 5) and a dumping position, loading position, or raised position. In the use position, the bed 200 may extend substantially horizontally (e.g., generally parallel to the frame 12). The use position may be used when holding or transporting a payload of the bed 200. In the loading position, the bed 200 may be rotated about the rotation 202 such that the front end of the bed 200 moves upward. Accordingly, the bed 200 declines as the bed 200 extends toward the rear end of the vehicle 10.

As shown in FIGS. 2, 37, and 38, the vehicle 10 includes an actuator (e.g., an electric linear actuator, a hydraulic cylinder, etc.), shown as bed actuator 204. A lower end of the bed actuator 204 is pivotably coupled to the frame 12, and an upper end of the bed actuator 204 is pivotably coupled to the bed 200. By extending the bed actuator 204, the bed actuator 204 may apply an upward force to raise the bed 200 to the loading position. By retracting the bed actuator 204, the bed actuator 204 may permit gravity to lower the bed 200 to the use position. Alternatively, the bed actuator 204 may apply an active retractive force to hold the bed 200 in the use position. Operation of the bed actuator 204 may be controlled by the vehicle control system 100. Additionally or alternatively, a front end of the bed 200 may selectively be fastened to the frame 12 (e.g., through the bracket 470) to secure, fix, or retain the bed 200 in the use position. In such an embodiment, the bed actuator 204 may be omitted, and the bed 200 may be manually repositioned.

Referring to FIGS. 4 and 5, the front row seating 32 includes a first seat portion or horizontal seat portion, shown as seat bottom 210, and a vertical seat portion, shown as seat back 212. Together, the seat bottom 210 and the seat back 212 form a seat that is configured to support one or more operators or passengers of the vehicle 10. The seat bottom 210 is coupled to the frame 12 and extends substantially horizontally. The seat back 212 is coupled to the frame 12, is positioned behind the seat bottom 210, and extends substantially vertically. The seat bottom 210 may support a bottom of an operator, whereas the seat back 212 may support a back of the operator.

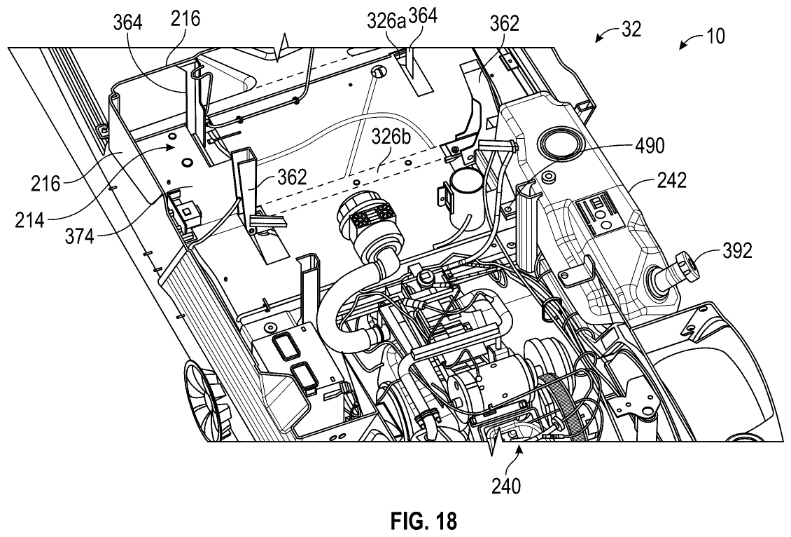

The body 20 defines a storage volume, storage area, or storage compartment, shown as storage compartment 214, positioned beneath the seat bottom 210. The body 20 includes a series of side panels or body panels, shown as seat body panels 216, that extend upward from the frame 12 to the seat bottom 210 to define the storage compartment 214. Specifically, the body 20 includes a pair of laterally-facing seat body panels 216 along the left and right sides of the body 20, and a front-facing seat body panel 216 extends laterally between the other two seat body panels 216. As shown in FIG. 18, a floor pan 374 defines a bottom boundary of the storage compartment 214. Accordingly, the storage compartment 214 may extend between the floor pan 374, the seat body panels 216, and the seat bottom 210.

In some embodiments, the storage compartment 214 is a partially or completely open space, such that the storage compartment 214 can be used to store one or more items. In some embodiments, the storage compartment 214 includes at least some space that is not occupied by components of the vehicle 10, such that a user can fill the storage compartment 214 with one or more items (e.g., sporting equipment, tools, food and beverages, etc.). As shown in FIG. 5, the seat bottom 210 is repositionable between a first, lowered, or seating position (shown in solid lines) and a second, raised, or access position (shown in dashed lines). By way of example, the seat bottom 210 may be pivotably coupled to the frame 12 (e.g., pivotably coupled to the 360), such that the seat bottom 210 is rotatable about a lateral axis. In the seating position, the seat bottom 210 extends between the seat body panels 216, limiting (e.g., preventing) access to the storage compartment 214. In the raised position, the seat bottom 210 may be moved away from the seat body panels 216, such that the storage compartment 214 may be accessed from above through an opening that extends between the seat body panels 216.

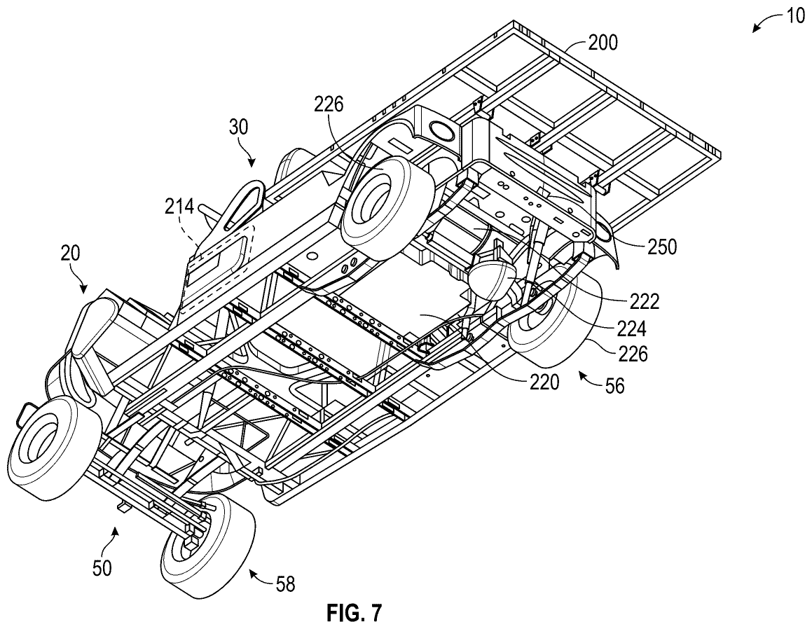

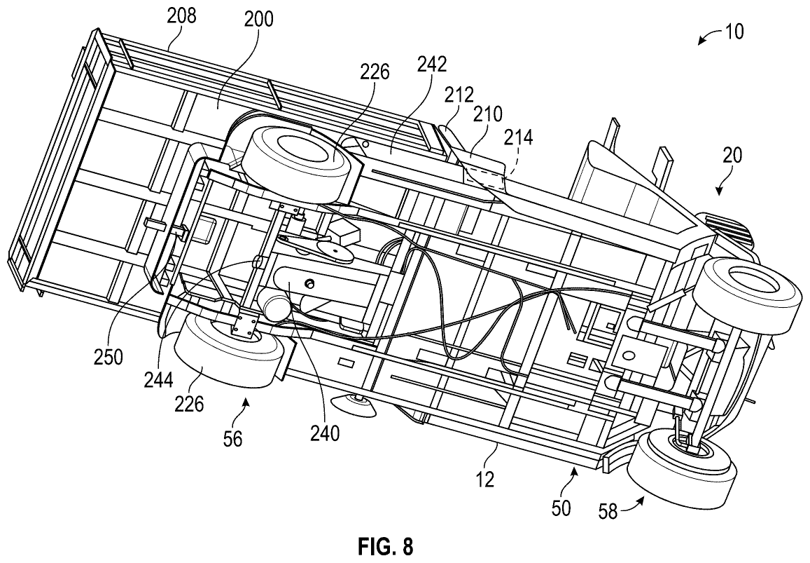

The vehicle 10 may be usable with drivelines 50 utilizing internal combustion engines and/or electric motors. Accordingly, the vehicle 10 may be an electric driveline, an internal combustion driveline, or a hybrid driveline. FIG. 7 illustrates an electric configuration of the vehicle 10 with an electric driveline. FIG. 8 illustrates an internal combustion configuration of the vehicle 10 with a driveline including an internal combustion engine. Other components of the vehicle 10 (e.g., components other than the driveline 50) may be consistent (e.g., in position and function) throughout both configurations of the vehicle 10. Accordingly, a common main portion of the vehicle 10 (e.g., including the frame 12, the body 20, the bed 200, the seat frame 360, etc.) may be manufactured and used for both configurations of the vehicle 10. Beneficially, this may reduce complexity and redundancy in the manufacturing process while still permitting production of both configurations.

Referring to FIGS. 7, 25, 26, and 32, the vehicle 10 is shown with a driveline 50 configured as an electrified driveline including an energy storage device, battery pack, or battery module, shown as battery pack 220, and a prime mover or electric motor (e.g., a DC electric motor, an AC electric motor, etc.), shown as electric motor 222. The battery pack 220 may represent the energy storage 54, the battery module 57, and/or the add-on battery module(s) 59. The electric motor 222 may represent the prime mover 52 and/or the motor 53. Accordingly, the driveline 50 may operate as shown and described with respect to FIG. 3.

The electric motor 222 may be included in the rear tractive assembly 56. An output of the electric motor 222 is coupled to a power transmission (e.g., a gearbox, a differential, etc.), shown as transmission 224. The transmission 224 couples the output of the electric motor 222 to a pair of tractive elements, shown as rear wheels 226. By way of example, the transmission 224 may include a differential coupled to a pair of half axles, each half axle being connected to a rear wheel 226.

As shown, the battery pack 220 and the electric motor 222 are approximately laterally centered within the vehicle 10 (e.g., positioned along a longitudinal centerline of the vehicle 10). The battery pack 220 and the electric motor 222 are positioned beneath the bed 200. The battery pack 220 is positioned rearward of the storage compartment 214 and the seat back 212. The electric motor 222 is oriented laterally and positioned above the transmission 224. The electric motor 222 and the transmission 224 are positioned behind the battery pack 220.

During operation, the electric motor 222 may consume electrical energy from the battery pack 220 and provide rotational mechanical energy to the transmission 224 (e.g., through an output shaft of the electric motor 222). The transmission 224 may distribute the rotational mechanical energy to the wheels 226 to drive the rear wheels 226. Accordingly, the electric motor 222 may drive the rear tractive assembly 56 to propel the vehicle 10.

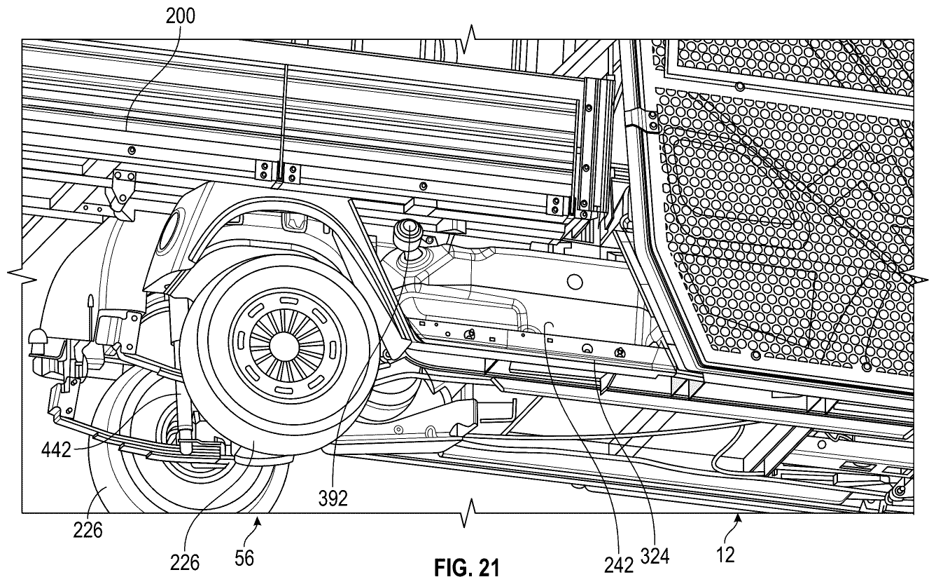

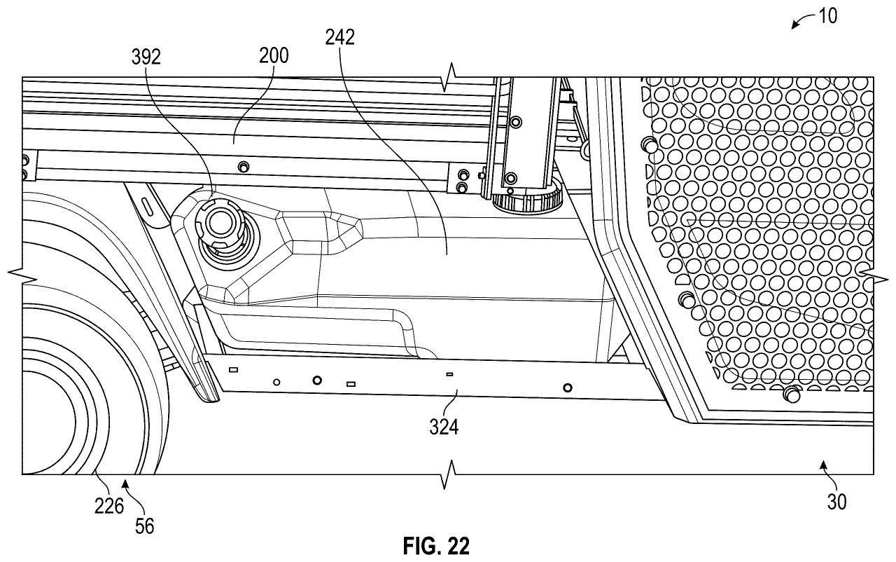

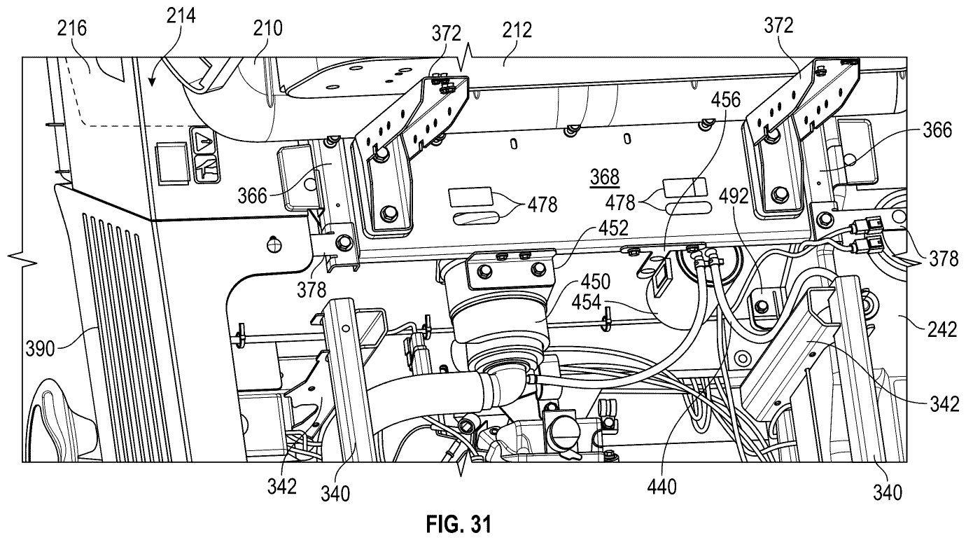

Referring to FIGS. 8, 18, 20-24, 28, and 31, the vehicle 10 is shown with a driveline 50 configured as an internal combustion driveline including a prime mover or internal combustion engine (e.g., spark-ignition internal combustion engine or a compression-ignition internal combustion engine, etc.), shown as engine 240, and an energy storage device or fuel tank, shown as fuel tank 242. The engine 240 may represent the prime mover 52. The fuel tank 242 may represent the energy storage 54 and may contain a fuel for use by the engine 240 (e.g., gasoline, diesel, ethanol, natural gas, propane, etc.).

The engine 240 may be included in the rear tractive assembly 56. An output of the engine 240 is coupled to a power transmission (e.g., a gearbox, a differential, etc.), shown as transmission 244. The transmission 244 couples the output of the engine 240 to a pair rear wheels 226. By way of example, the transmission 244 may include a differential coupled to a pair of half axles, each half axle being connected to a rear wheel 226.

As shown, the engine 240 is approximately laterally centered within the vehicle 10 (e.g., positioned along a longitudinal centerline of the vehicle 10). The fuel tank 242 is laterally offset from the longitudinal centerline, such that the fuel tank 242 is positioned along a laterally-facing side of the vehicle 10 (e.g., a left side or a right side). The engine 240 and the fuel tank 242 are positioned beneath the bed 200. The engine 240 is positioned rearward of the storage compartment 214 and the seat back 212. The fuel tank 242 is positioned rearward of the storage compartment 214. The engine 240 may extend farther rearward than the fuel tank 242.

During operation, the engine 240 may consume (e.g., combust) fuel from the fuel tank 242 and provide rotational mechanical energy to the transmission 244 (e.g., through an output shaft of the engine 240). The transmission 244 may distribute the rotational mechanical energy to the wheels 226 to drive the rear wheels 226. Accordingly, the engine 240 may drive the rear tractive assembly 56 to propel the vehicle 10.

As shown in FIGS. 7 and 8, the vehicle 10 further includes a towing interface (e.g., a tow point, a towing ball, a tow hook, a tow eye, etc.), shown as tow point 250. The tow point 250 is fixedly coupled to the frame 12 and extends rearward from the frame 12. The tow point 250 may provide an interface through which a trailed load or trailed implement (e.g., a flatbed trailer, a covered trailer, a wood chipper, a log splitter, a sweeper, a vacuum, etc.) may be selectively coupled to the frame 12. In some embodiments, the vehicle 10 is capable of towing at least about 1500 pounds (e.g., at least 1350 pounds, at least 1500 pounds, at least 1650 pounds, etc.).

### Frame Configuration

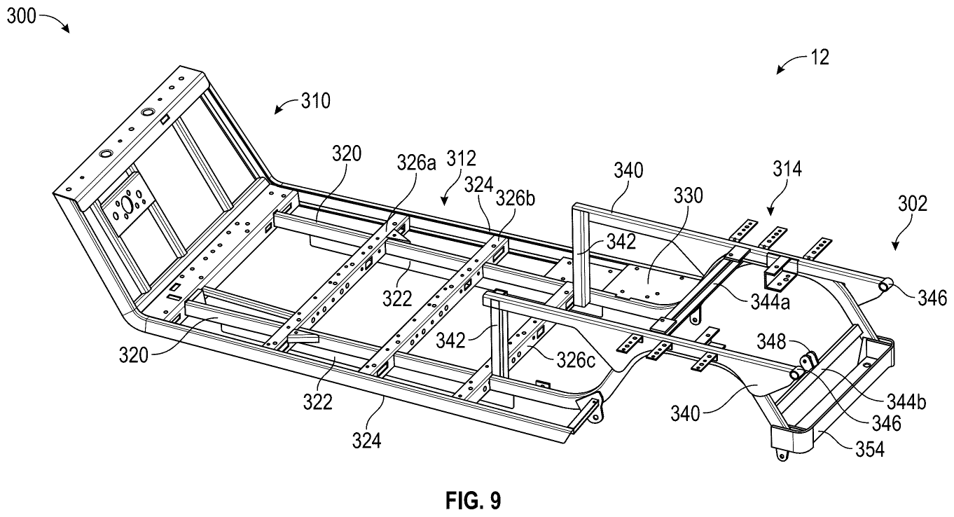

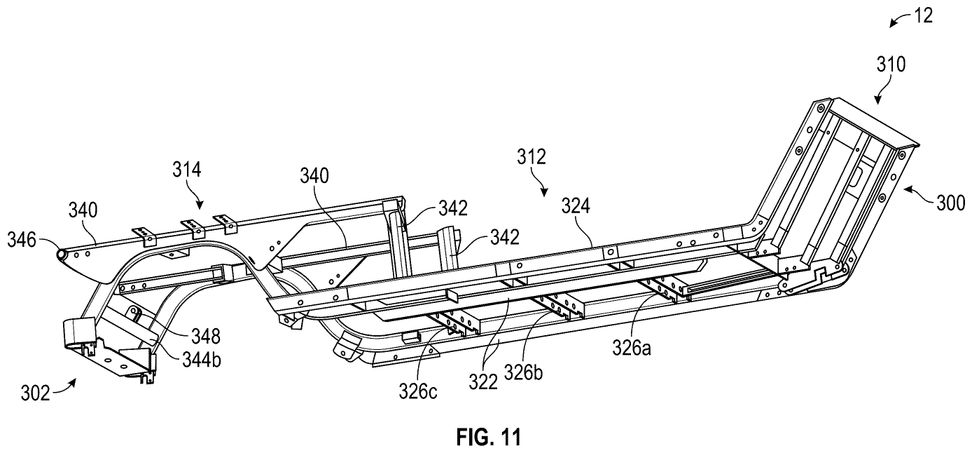

Referring to FIGS. 9-12, the frame 12 is shown according to an exemplary embodiment. The frame 12 extends longitudinally, having a length that extends from a front end 300 of the frame 12 to a rear end 302 of the frame 12. During normal travel of the vehicle 10, the vehicle 10 may move parallel to the length of the 12, with the front end 300 traveling at the front of the vehicle 10. The frame 12 includes a series of frame members that may be fixedly coupled to one another by welding, forming a weldment.

The frame 12 includes a first section, front section, or body section, shown as front section 310, a second section, middle section, or floor section, shown as floor section 312, and a third section, upper section, rear section, or bed section, shown as rear section 314. The front section 310 is positioned at the front end 300 and supports the body 20. The floor section 312 is positioned behind the front section 310 and supports the occupant seating area 30. The upper section 314 is positioned at the rear end rear end 302 and supports the bed 200.

The frame 12 includes a pair of longitudinal frame members or frame rails, shown as main rails 320. The main rails 320 are laterally offset from one another (e.g., symmetrically about a longitudinal centerline of the frame 12). The main rails 320 extend longitudinally along the frame 12, extending within the front section 310, the floor section 312, and the rear section 314. The main rails 320 extend substantially horizontally within the front section 310 and the floor section 312. In the rear section 314, the main rails 320 are bent upward and then downward, forming a shape that is concave downward. The curved shape of the main rails 320 in the rear section 314 may provide clearance for the rear tractive assembly 56 within the frame 12.

The frame 12 includes a pair of longitudinal frame members or frame rails (e.g., doubler tubes, stiffeners, etc.), shown as doubler tubes 322. The doubler tubes 322 are tubular members that extend longitudinally and horizontally. Each doubler tube 322 extends along a bottom surface of one of the main rails 320, such that the doubler tube 322 extends beneath the main rail 320. The main rails 320 are fixedly coupled (e.g., welded) to the bottom surfaces of the main rails 320. The doubler tubes 322 increase the vertical dimension of the frame 12 where the frame 12 may otherwise be weakest, reducing deflection and bending stresses caused by vertical loads on the frame 12.

The frame 12 includes a pair of longitudinal frame members or frame rails, shown as outer longitudinal rails 324. The outer longitudinal rails 324 are laterally offset from one another (e.g., symmetrically about a longitudinal centerline of the frame 12). A lateral distance between the outer longitudinal rails 324 is greater than a lateral distance between the main rails 320, such that the main rails 320 are positioned between the outer longitudinal rails 324. The outer longitudinal rails 324 extend longitudinally along the frame 12, extending within the front section 310 and the floor section 312. The outer longitudinal rails 324 extend at a frontward incline within the front section 310 and substantially horizontally within the floor section 312.

The floor section 312 includes a series of lateral frame members, shown as cross members 326a, 326b, and 326c. The cross members 326a, 326b, and 326c each extend laterally across the frame 12. The cross member 326a is positioned forwardmost of the cross members. The cross member 326b is offset longitudinally behind the cross member 326a. The cross member 326c is offset longitudinally behind the cross member 326c.

The cross member 326a has a first end fixedly coupled to one of the outer longitudinal rails 324 and an opposing second end fixedly coupled to the other of the outer longitudinal rails 324. The cross member 326a is further fixedly coupled to each of the main rails 320. Accordingly, the cross member 326a extends laterally between the first outer longitudinal rail 324 and one of the main rails 320, between the main rails 320, and between the other of the main rails 320 and the second outer longitudinal rails 324. The cross member 326b has a similar arrangement to the cross member 326a.

Referring to FIGS. 9-14, the cross member 326c has a similar arrangement to the cross member 326a, except the cross member 326c is shortened such that the first end of the cross member 326c is fixedly coupled to one of the main rails 320. This arrangement forms a gap between the first end of the cross member 326c and the nearest outer longitudinal rail 324 (i.e., the cross member 326c does not cross the gap between the main rail 320 and the outer longitudinal rail 324). This gap may provide clearance for one or more components (e.g., the splash pan 330).

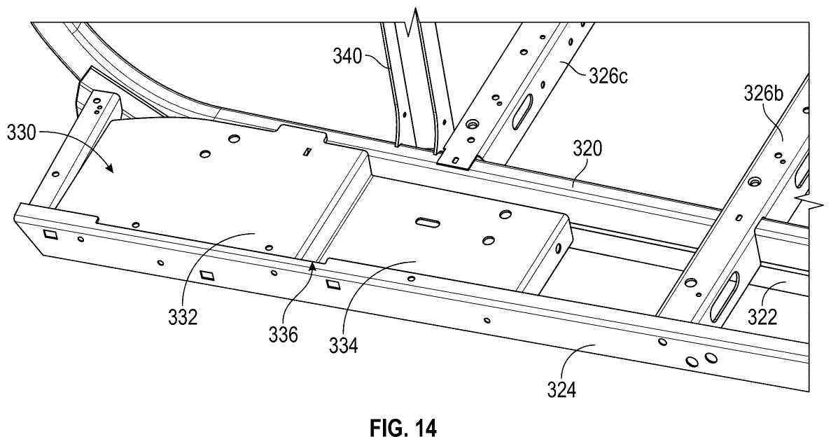

Referring to FIG. 14, the frame 12 includes a plate, shown as splash pan 330, within the floor section 312. The splash pan 330 is positioned between the main rail 320 and the outer longitudinal rail 324 on the right (e.g., passenger) side of the vehicle 10. The splash pan 330 occupies the gap formed by the reduced length of the cross member 326c. The splash pan 330 is fixedly coupled (e.g., welded) to the main rail 320 and the outer longitudinal rail 324. The splash pan 330 includes a first flat portion or horizontal portion, shown as upper section 332, and a second flat portion or horizonal portion, shown as lower section 334. The lower section 334 is positioned longitudinally forward of the upper section 332. The lower section 334 is vertically offset below the upper section 332, such that the lower section 334 extends lower than the upper section 332. The upper section 332 meets the lower section 334 at a transition, shown as step 336, such that the splash pan 330 is formed from a single, continuous piece of material.

Referring to FIGS. 9-13, the rear section 314 of the frame 12 includes a pair of longitudinal frame members or frame rails, shown as upper rails 340. The upper rails 340 are laterally offset from one another (e.g., symmetrically about a longitudinal centerline of the frame 12). The upper rails 340 extend longitudinally along the frame 12 and substantially horizontally. In some embodiments, the bed 200 rests atop the upper rails 340. The upper rails 340 each have a C-shaped cross section and received a rear end portion of one of the main rails 320 to fixedly couple the upper rail 340 to the corresponding main rail 320.

The rear section 314 of the frame 12 further includes a pair of vertical frame members, shown as uprights 342. A bottom end portion of each upright 342 is fixedly coupled to one of the main rails 320, and an upper end portion is fixedly coupled to a corresponding one of the upper rails 340. The upper end portion of each upright 342 defines a recess, shown as cradle 350, that receives a front end portion of the corresponding upper rail 340. Accordingly, the uprights 342 support and fixedly couple front end portions of the upper rails 340 to the main rails 320. The uprights 342 are positioned immediately rearward of the cross member 326c. The uprights 342 each has a C-shaped cross section and defines a recess, shown as cutout 352, that extends laterally inward (i.e., inward toward a longitudinal centerline of the vehicle 10). The cutouts 352 may provide clearance for other components of the vehicle 10 (e.g., the fuel tank 242).

The rear section 314 includes a pair of lateral frame members, shown as cross members 344a and 344b. The cross members 344a and 344b each extend laterally across the frame 12. The cross member 344a is positioned forward of the cross member 344b and above the cross member 344b. The ends of the cross member 344a are fixedly coupled to the upper rails 340. The ends of the cross member 344b are fixedly coupled to the main rails 320.

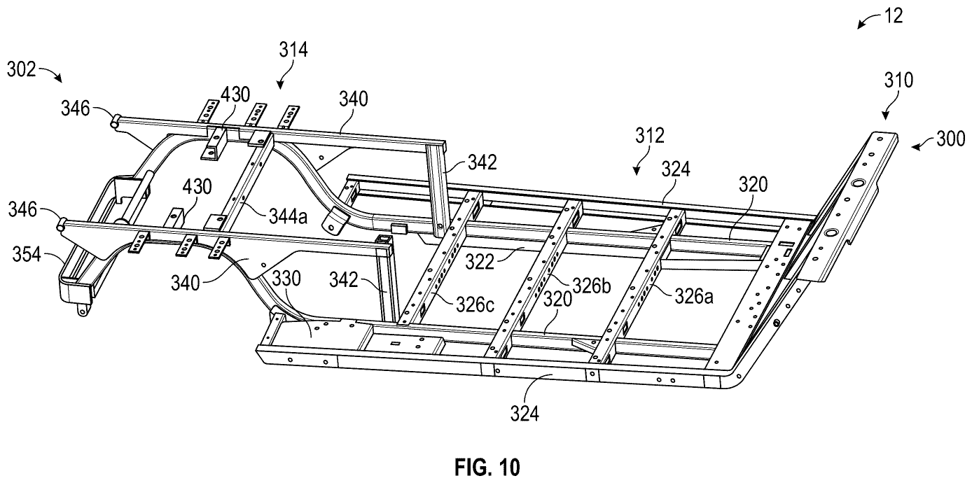

Referring to FIGS. 9 and 10, the frame 12 includes a pair of pivot points or bearings, shown as bed pivots 346. The bed pivots 346 are configured to provide a mounting location about which the bed 200 may pivot. The bed pivots 346 may be pivotably coupled to the bed 200 by a pair of pins, for example. Each bed pivot 346 is fixedly coupled to a rear end of one of the upper rails 340. The bed pivots 346 are aligned with one another and centered about the axis of rotation 202.

When the bed 200 is in the use position (e.g., as shown in FIG. 5), the bed 200 may rest atop the upper rails 340 (e.g., atop one or more bumpers coupled to the upper rails 340). Accordingly, vertical loading on the bed 200 (e.g., from a load supported on the bed 200) may be partially or entirely supported by the upper rails 340. This vertical loading may be transferred through the uprights 342 to the main rails 320. Accordingly, by supporting the front ends of the upper rails 340 with the uprights 342 (e.g., through the cradle 350), the payload capacity of the bed 200 may be increased.

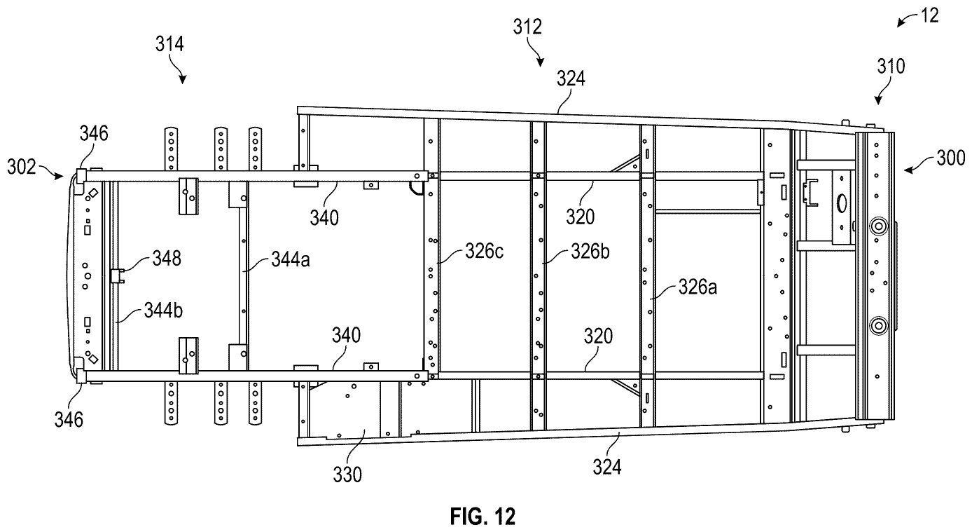

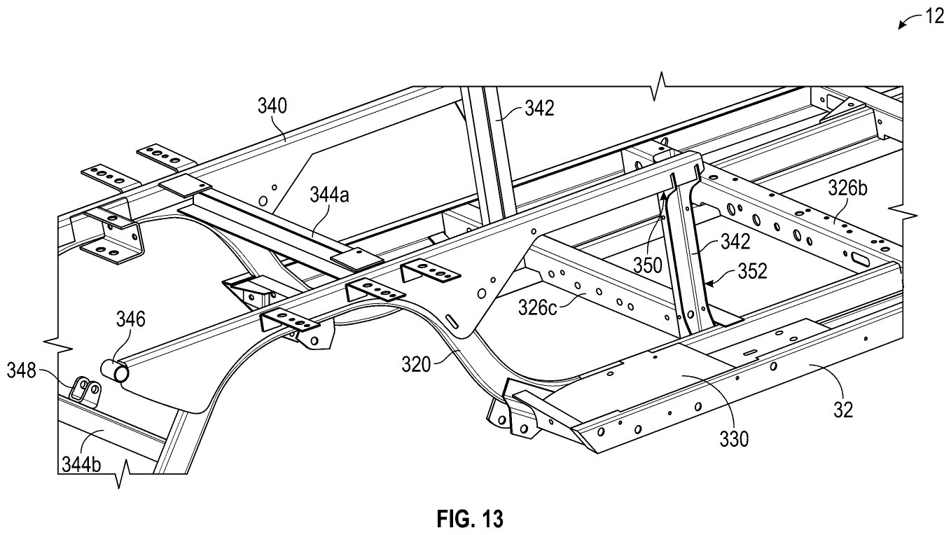

Referring to FIGS. 12 and 13, the frame 12 includes a pivot point, bearing, or clevis, shown as bed actuator pivot 348. The bed actuator pivot 348 is configured to provide a mounting location about which a lower end of the bed actuator 204 may pivot. The bed actuator pivot 348 may be pivotably coupled to the bed actuator 204 by a pin, for example. The bed actuator pivot 348 is fixedly coupled to the cross member 344b and laterally centered on the frame 12.

Referring to FIG. 9, the rear section 314 includes a lateral frame member, shown as tow bar 354. The tow bar 354 extends laterally across the frame 12. The tow bar 354 is positioned at the rear end 302. The ends of the tow bar 354 are fixedly coupled to the rear ends of the main rails 320. The tow bar 354 may provide a connection point to secure the tow point 250 to the frame 12.

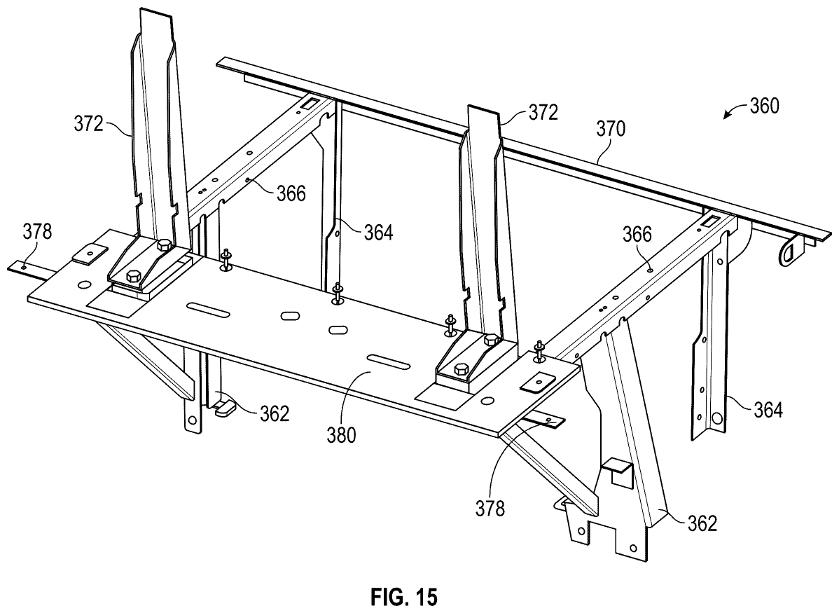

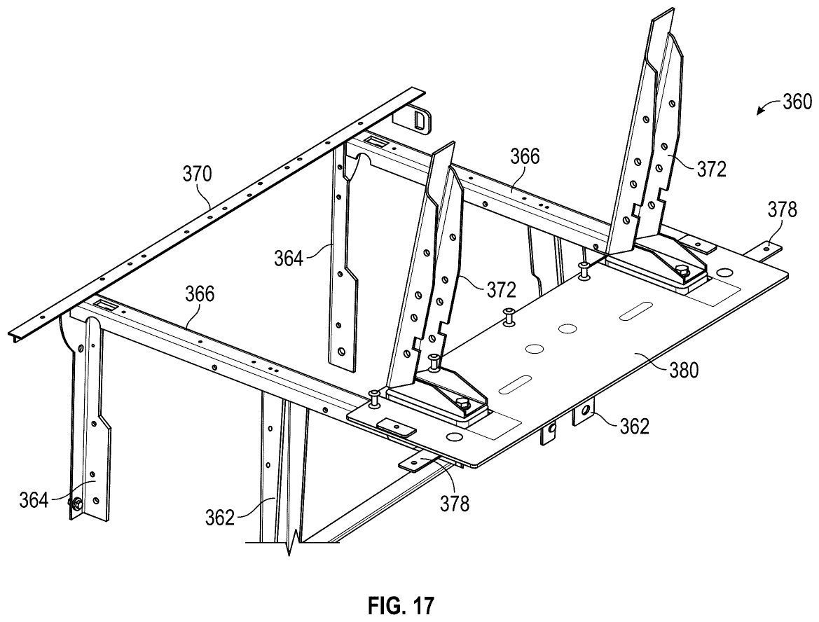

Referring to FIGS. 15-17, the vehicle 10 further includes a subframe or frame assembly, shown as seat frame 360. The seat frame 360 is fixedly coupled to the frame 12 and extends above the frame 12 to support the seat bottom 210 and the seat back 212. Together, the seat frame 360, the seat bottom 210, and the seat back 212 form a seat configured to support an operator and/or one or more passengers. In some embodiments, the components of the seat frame 360 are fixedly coupled to one another, forming a weldment.

The seat frame 360 includes a series of vertical frame members, shown as rear uprights 362 and front uprights 364. The rear uprights 362 are laterally offset from one another. The front uprights 364 are laterally offset from one another and offset longitudinally forward of the rear uprights 362. A pair of longitudinal frame members, shown as longitudinal frame members 366, extend longitudinally. Each longitudinal frame member 366 extends from an upper end of one of the rear uprights 362 to an upper end of one of the front uprights 364. The longitudinal frame members 366 are each fixedly coupled to the corresponding rear upright 362 and front upright 364.

The seat frame 360 further includes a first lateral frame member or cross member, shown as seat mount 368, that extends laterally between the rear ends of the longitudinal frame members 366. The seat mount 368 is generally flat and horizontal. The seat mount 368 is fixedly coupled to the longitudinal frame members 366. A second lateral frame member or cross member, shown as front cross member 370, extends laterally between the front ends of the longitudinal frame members 366. The front cross member 370 is fixedly coupled to the longitudinal frame members 366.

A pair of vertical frame members, shown as seat back uprights 372, extend upward from the seat mount 368. A lower end of each seat back upright 372 is fixedly coupled to the seat mount 368, holding the seat back uprights 372 in place. The seat back uprights 372 extend along a rear side of the seat back 212. The seat back uprights 372 are fixedly coupled to the seat back 212, such that the seat frame 360 fixedly couples the seat back 212 to the frame 12.

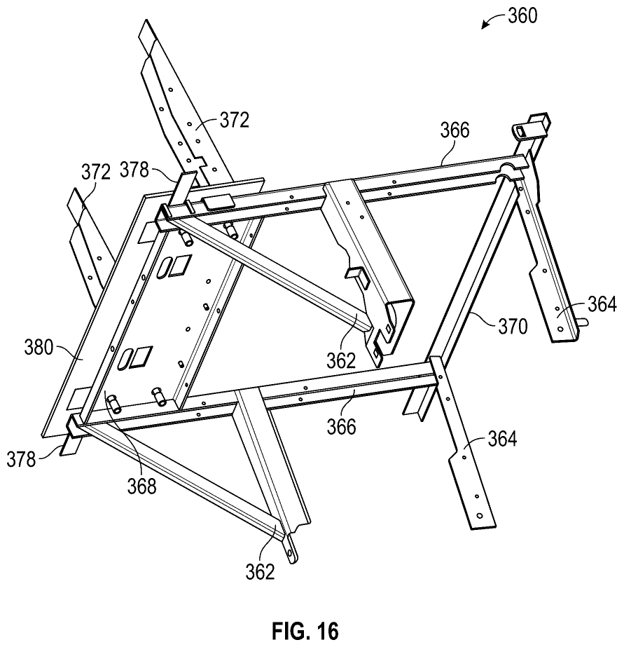

Referring to FIGS. 16, 17, and 31, the seat frame 360 further includes a pair of lateral extensions or tabs, shown as side panel brackets 378. The side panel brackets 378 are each fixedly coupled to one of the longitudinal frame members 366 at a rear end of the longitudinal frame member 366. The side panel brackets 378 extend laterally outward from the longitudinal frame members 366 (e.g., away from a longitudinal centerline of the frame 12).

Referring to FIGS. 15, 17, and 29, the vehicle 10 includes a compliant member, cover, or mat, shown as rear cover mat 380, that rests atop the seat mount 368, the longitudinal frame members 366, and the side panel brackets 378. The rear cover mat 380 extends around the back uprights 372, which extend upward from the seat mount 368 and through the rear cover mat 380. The rear cover mat 380 may extend beneath a front end of the bed 200. The rear cover mat 380 may extend between the seat bottom 210 and the front end of the bed 200 to prevent items (e.g., items carried by an operator, debris, etc.) from falling between the seat bottom 210 and the bed 200 and becoming lodged within the vehicle 10.

Referring to FIGS. 18, 19, and 31, the seat frame 360 is shown coupled to the frame 12. The lower ends of the front uprights 364 are each fixedly coupled to the cross member 326a. The lower ends of the rear uprights 362 are each fixedly coupled to the cross member 326b. The seat frame 360 is offset longitudinally forward of the uprights 342. The seat frame 360 (and thus the seat formed by the seat frame 360) are directly coupled to the frame 12 and separate from the uprights 342. Accordingly, the load of an occupant seated on the seat bottom 210 may be directed to the main rails 320 without passing a load through the upper rails 340 or the uprights 342. This arrangement may separate the load on the seat bottom 210 from the load on the bed 200, increasing the payload capacity of the bed 200.

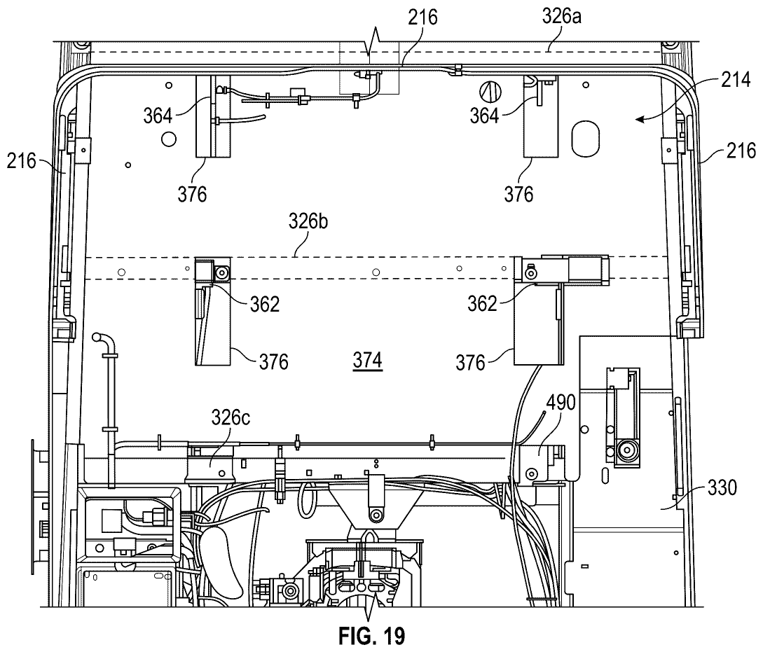

The seat frame 360 is positioned within the storage compartment 214, such that the seat frame 360 is surrounded on the front, left, and right sides by the seat body panels 216. A plate or belly pan, shown as floor pan 374, is fixedly coupled to the frame 12 and extends along top surfaces of the main rails 320, the outer longitudinal rails 324, the cross member 326a, the cross member 326b, and the cross member 326c. The floor pan 374 may define a support surface for items contained within the storage compartment 214. Additionally, the floor pan 374 may protect the storage compartment 214 from exposure to debris from below (e.g., road debris). As shown in FIGS. 18 and 19, the floor pan 374 defines a series of apertures, passages, or cutouts, shown as cutouts floor pan 376, through which the front uprights 364 and the rear uprights 362 extend to reach the frame 12.

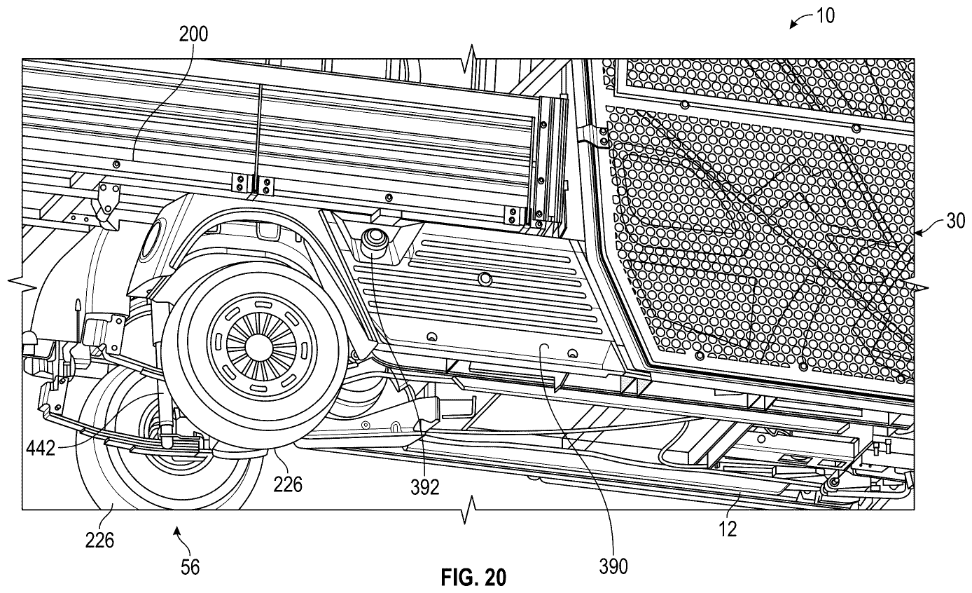

Referring to FIGS. 20, 25, 28, 31, and 32, the body 20 includes a pair of body panels or covers, shown as side panels 390. The side panels 390 extend along the laterally-facing sides of the vehicle 10 (i.e., the left side and the right side). The side panels 390 extend longitudinally between the seat body panels 216 and wheel wells that receive the seat body panels 216. The side panels 390 extend from the outer longitudinal rails 324 to immediately beneath the bed 200. The side panels 390 are fixedly coupled to the frame 12 (e.g., the outer longitudinal rails 324 of the frame 12). An upper front end of each side panels 390 is fixedly coupled to one of the side panel brackets 378 (e.g., with one or more fasteners). Accordingly, the side panels 390 are supported by both the frame 12 and the seat frame 360. The side panels 390 may be present on both the electrified and internal combustion variants of the vehicle 10.

Referring to FIGS. 20-24, a position of the fuel tank 242 is shown, according to an exemplary embodiment. As shown, the fuel tank 242 is positioned along a right side or passenger side of the vehicle 10, immediately laterally inward of a side panel 390. Accordingly, the side panel 390 covers the fuel tank 242. In other embodiments, the fuel tank 242 is positioned on a left side or driver side of the vehicle 10.

The fuel tank 242 includes an inlet or spout, shown as fill tube 392, that extends laterally outward through the side panel 390. The fill tube 392 is fluidly coupled to an internal volume of the fuel tank 242 and provides an interface through which a user may add fuel to the fuel tank 242. The fill tube 392 may include a cap or cover that selectively blocks the fill tube 392 to prevent ingress of debris into the fuel tank 242.

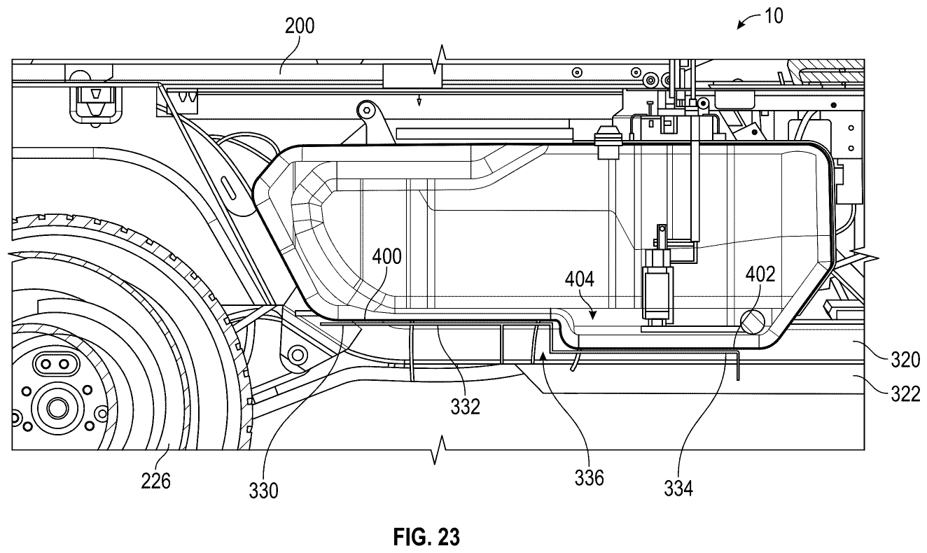

Referring to FIG. 23, a depth of the fuel tank 242 varies throughout the fuel tank 242. The fuel tank 242 includes a first section, raised section, or rear portion, shown as shallow section 400, and a second section, lowered section, or front portion, shown as deep section 402. The deep section 402 is positioned vertically forward of the shallow section 400. The shallow section 400 is offset vertically above the deep section 402, such that the fuel tank 242 forms a step, shown as step recess 404, between the shallow section 400 and the deep section 402. The change in depth may, for example, facilitate the fuel settling near an inlet of a pump that draws the fuel out of the fuel tank 242.

The fuel tank 242 rests atop the splash pan 330, such that the splash pan 330 extends beneath the fuel tank 242. The splash pan 330 may support the fuel tank 242 and prevent both (a) fuel from the fuel tank 242 from dripping downward and (b) debris from the ground from contacting the fuel tank 242. The splash pan 330 is shaped to correspond with the changing depth of the fuel tank 242. Specifically, the upper section 332 extends beneath and supports the shallow section 400, and the lower section 334 extends beneath and supports the deep section 402. The deep section 402 may extend between the main rail 320 and the outer longitudinal rail 324 nearest the fuel tank 242. The step recess 404 receives the step 336 of the splash pan 330. Accordingly, the splash pan 330 is shaped to support the entire length of the fuel tank 242.

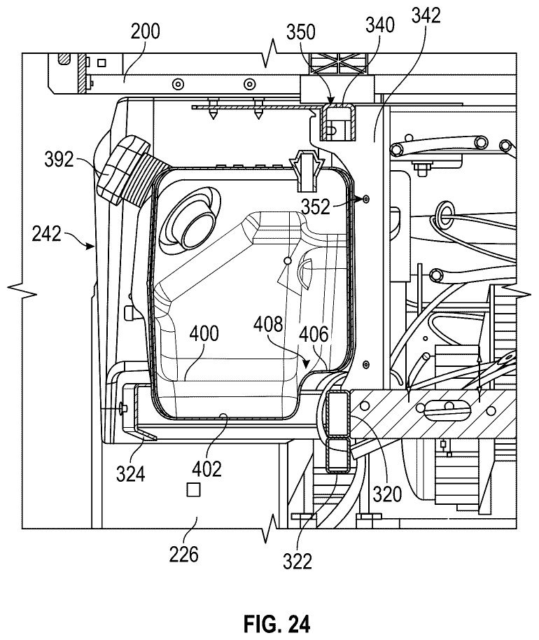

Referring to FIG. 24, the fuel tank 242 further includes a third section, raised section, or side portion, shown as shallow section 406. The shallow section 406 is positioned laterally inward of the shallow section 400 and the deep section 402. The shallow section 406 is offset vertically above the deep section 402, such that the fuel tank 242 forms a step, shown as step recess 408, between the deep section 402 and the shallow section 406. The change in depth may, for example, facilitate the fuel settling near an inlet of a pump that draws the fuel out of the fuel tank 242. In some embodiments, the depth of the shallow section 400 is substantially equal to the depth of the shallow section 406.

The shallow section 406 of the fuel tank 242 extends over the main rail 320, such that the main rail 320 extends beneath the fuel tank 242. The shallow section 406 extends laterally inward toward an upright 342, such that the cutout 352 of the upright 342 receives the shallow section 406. If the upright 342 were formed without the cutout 352, the upright 342 might otherwise interfere with the placement of the fuel tank 242, forcing the fuel tank 242 laterally outward.

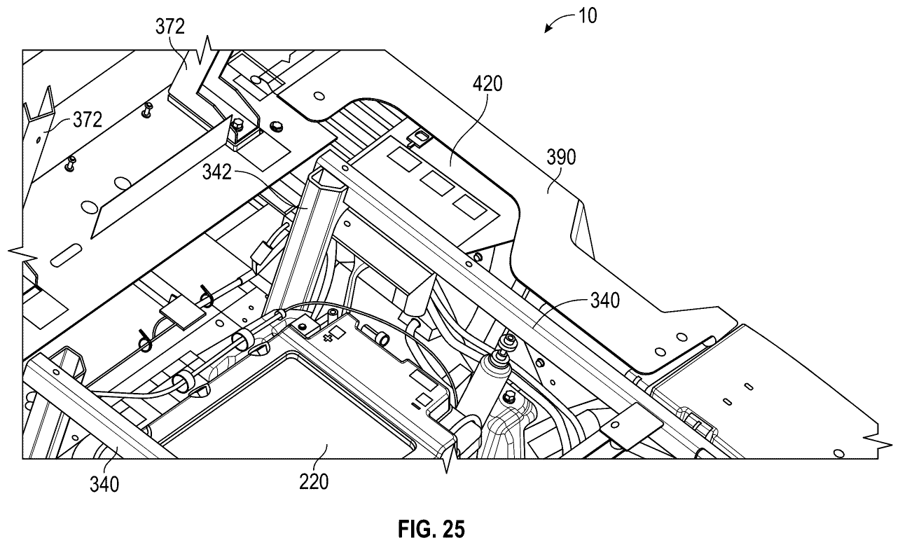

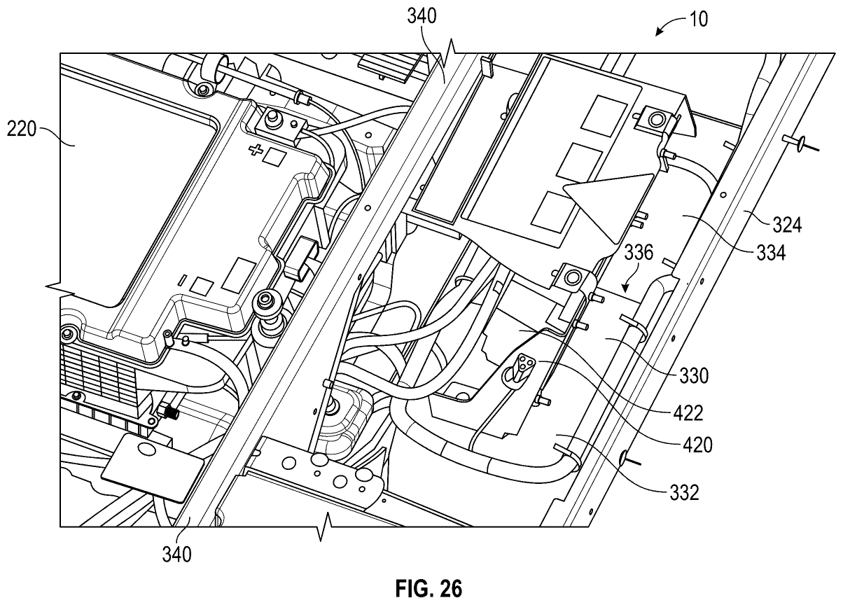

Referring to FIGS. 25 and 26, in the electrified variant of the vehicle 10, the fuel tank 242 is omitted. Instead, the space vacated by the fuel tank 242 (e.g., the space covered by the side panel 390) is occupied by a support, shown as controller bracket 420, and a controller 422. The controller bracket 420 is fixedly coupled to the splash pan 330 and extends upward from the splash pan 330. The controller 422 is fixedly coupled to the controller bracket 420, such that the controller bracket 420 supports the controller 422. The controller 422 may represent a portion of the vehicle control system 100 (e.g., the processing circuit 102 and the memory 104). Beneficially, the splash pan 330 may be used to support components in both the electrified and internal combustion variants of the vehicle 10.

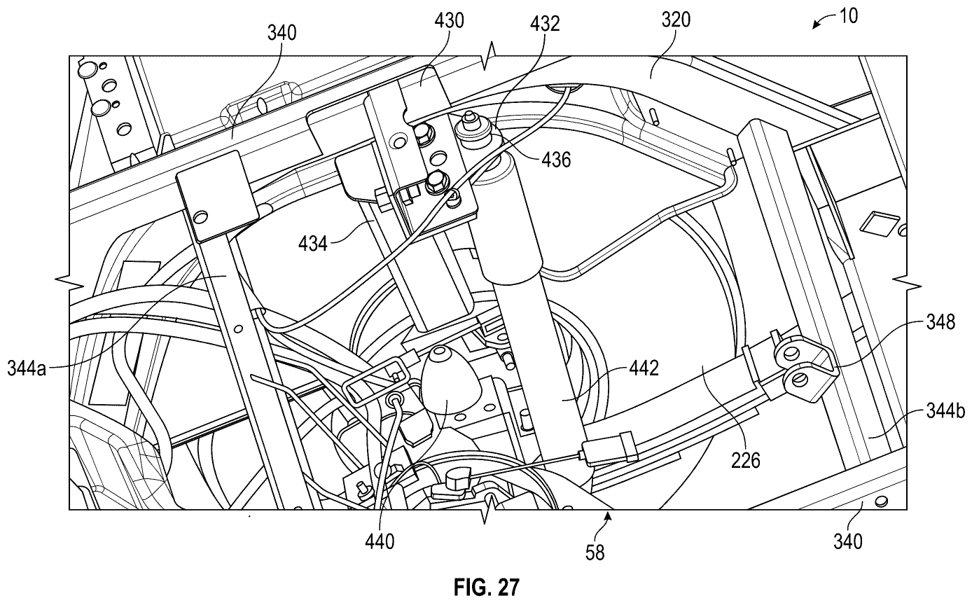

Referring to FIGS. 10, 27, and 28, the frame 12 includes a pair of brackets or supports, shown as shock mounts 430, that support one or more components of the suspension system 60. Each shock mount 430 is fixedly coupled to the upper rails 340 rearward of the cross member 344a. The shock mounts 430 extend laterally inward from the upper rails 340.

A bracket or support, shown as adapter bracket 432, is removably coupled to each of the shock mounts 430 (e.g., through one or more fasteners). The adapter bracket 432 includes a protrusion or stop, shown as travel limiting stop 434, that extends downward from the shock mount 430. The adapter bracket 432 further defines an aperture, passage, interface, or coupler, shown as shock mounting aperture 436, extending vertically through the adapter bracket 432. The combo bracket mounting aperture 436 is offset rearward of the shock mount 430, and the travel limiting stop 434 is offset forward of the shock mounting aperture 436 and the shock mount 430.

The rear tractive assembly 56 includes a bumper or bump stop, shown as jounce bumper 440, that extends upward toward the travel limiting stop 434. The jounce bumper 440 is aligned with the travel limiting stop 434, such that the jounce bumper 440 moves toward the travel limiting stop 434 when the rear tractive assembly 56 moves upward. The jounce bumper 440 and the travel limiting stop 434 may define an upper limit of the suspension travel of the rear tractive assembly 56. By way of example, the suspension system 60 may permit the rear tractive assembly 56 to move upward (e.g., when driving over a raised feature on the ground). When the rear tractive assembly 56 reaches the upper limit of the suspension travel (e.g., an uppermost position), the jounce bumper 440 engages the travel limiting stop 434 and limits (e.g., prevents, resists, etc.) further upward movement of the rear tractive assembly 56. In some embodiments, the jounce bumper 440 is made from a compliant material (e.g., rubber) to dampen this impact.

The suspension system 60 further includes a suspension element (e.g., a spring, a damper, a spring and damper assembly, etc.), shown as shock absorber 442. An upper end of the shock absorber 442 is coupled to the adapter bracket 432 by the shock mounting aperture 436 (e.g., the upper end extends through the shock mounting aperture 436). A lower end of the shock absorber shock absorber 442 is coupled to the rear tractive assembly 56. The shock absorber 442 may control motion of the rear tractive assembly 56 relative to the frame 12 (e.g., by applying a spring force and/or a damping force).

Beneficially, the adapter bracket 432 may permit both the travel limiting stop 434 and the shock absorber 442 to be coupled to a single shock mount 430. By longitudinally offsetting the travel limiting stop 434 from the shock mounting aperture 436, the adapter bracket 432 provides sufficient clearance for the jounce bumper 440 and the shock absorber 442 to operate without running into one another.

In other vehicles without the adapter bracket 432, a travel limiting stop and a shock absorber may require two separate mounts, increasing the complexity of the vehicle frame. In some embodiments, the adapter bracket 432 may be used to retrofit an existing bracket of a vehicle frame to accommodate both a travel limiting stop 434 and a shock mounting aperture 436. Because the adapter bracket 432 is bolted onto the shock mount 430, the adapter bracket 432 may be mounted without requiring a modification to a vehicle frame.

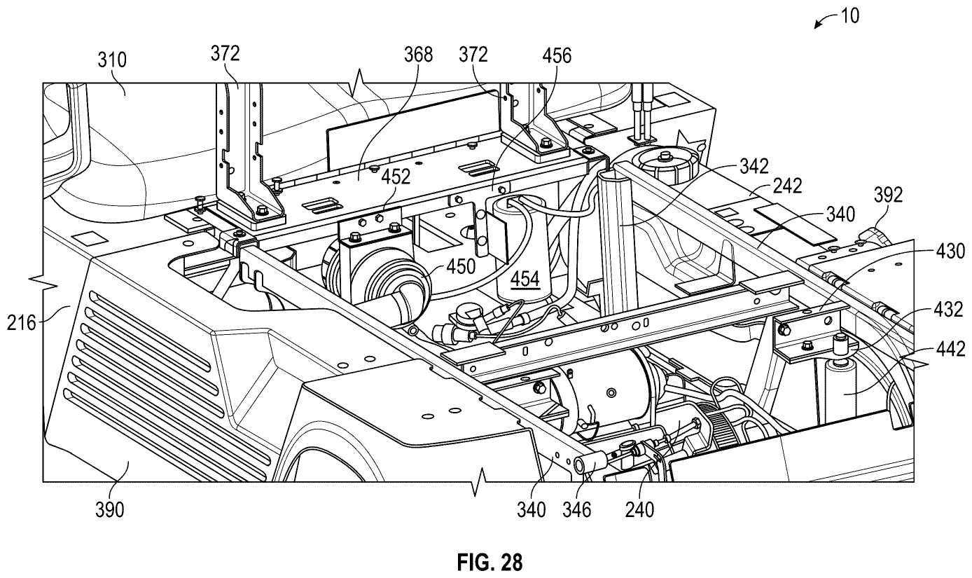

Referring to FIG. 28, the internal combustion variant of the vehicle 10 is shown according to an exemplary embodiment. The vehicle 10 includes an air intake component, shown as air intake 450, coupled to the seat frame 360 by a support or bracket, shown as air intake bracket 452. As shown, the air intake 450 is positioned forward of the engine 240, behind the storage compartment 214, and beneath the bed 200. The air intake 450 may represent any component through which air is supplied to the engine 240 (e.g., for combustion). By way of example, the air intake 450 may be or include a conduit (e.g., a hose, pipe, manifold, etc.), an air filter, a fan, or another air intake component. The air intake 450 is configured to supply air (e.g., from the surrounding environment) to the engine 240. The air may flow longitudinally through the air intake 450.

The vehicle 10 further includes a filter, environmental protection feature, or collector, shown as carbon canister 454, that is coupled to the seat frame 360 by a support or bracket, shown as carbon canister bracket 456. As shown, the carbon canister 454 is positioned forward of the engine 240, behind the storage compartment 214, and beneath the bed 200. The carbon canister 454 is fluidly coupled to the fuel tank 242 (e.g., through one or more hoses or other conduits). The carbon canister 454 is configured to capture contaminants released by the fuel tank 242. By way of example, the fuel within the fuel tank 242 may evaporate over time or in response to changes in temperature or other conditions. To prevent the evaporated fuel from building pressure within the fuel tank 242, fumes from the fuel tank 242 may be permitted to pass into the carbon canister 454. The carbon canister 454 may filter and contain the contaminants (e.g., hydrocarbons), preventing the contaminants from entering the surrounding atmosphere.

The air intake bracket 452 and the carbon canister 454 are each fixedly coupled to a rear surface of the seat mount 368 (e.g., by one or more fasteners). The rear surface of the seat mount 368 may extend substantially vertically and horizontally, and portions of the air intake bracket 452 and the carbon canister bracket 456 extend along the rear surface. As shown, the carbon canister bracket 456 has a T-shape including a lateral portion that extends along the rear surface of the seat mount 368. The T-shape of the carbon canister bracket 456 may limit (e.g., resist or prevent) rotation of the carbon canister bracket 456 about a vertical axis, increasing the stability of the carbon canister 454.

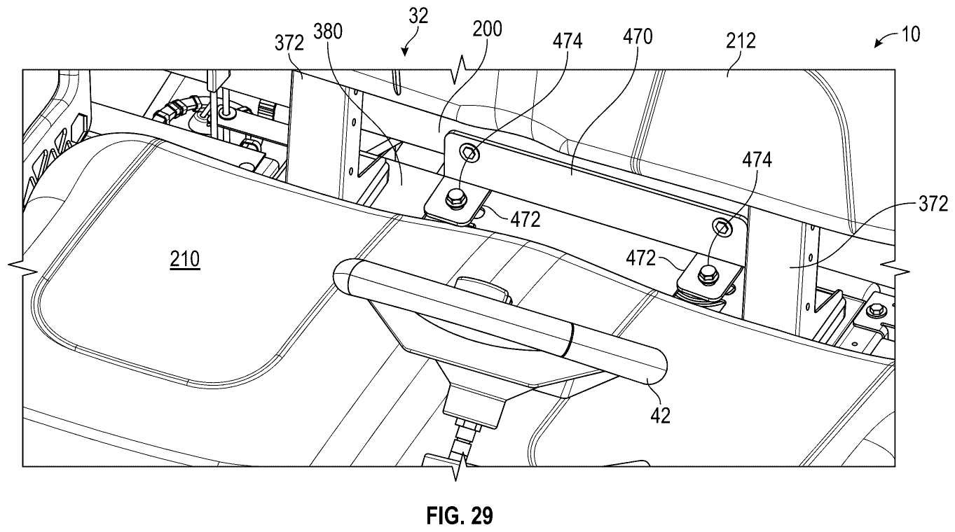

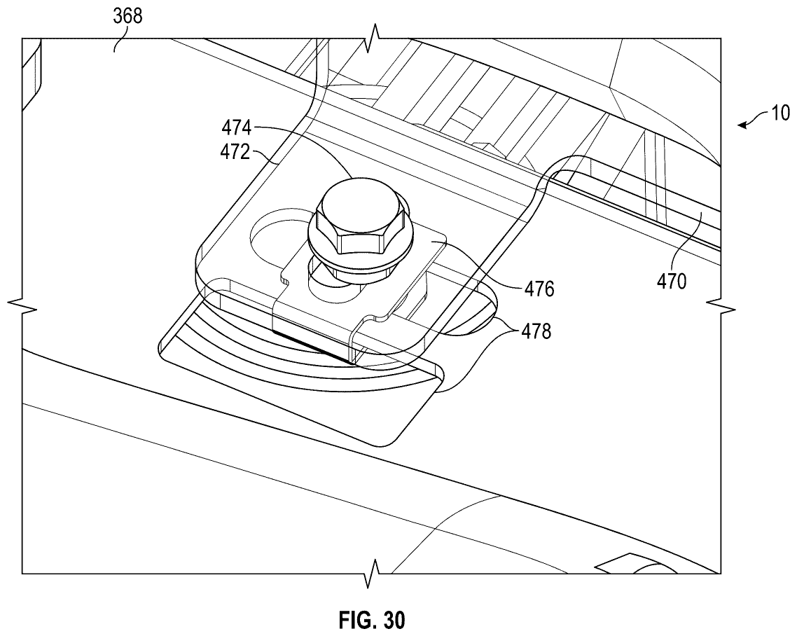

Referring to FIGS. 29-31, the bed 200 includes a mounting bracket, shown as bed mount 470. The bed mount 470 is positioned at a front end of the bed 200, such that the bed mount 470 may raise or lower with the front end of the bed 200. The bed mount 470 may be used to manually limit (e.g., prevent) the bed 200 from moving out of the use position and toward the dumping position.

The bed mount 470 includes a pair of protrusions or flanges, shown as tabs 472, that extend forward from the bed 200. When the bed 200 is in the use position (e.g., as shown in FIG. 29), the tabs 472 are substantially horizontal. A fastener, shown as bed mounting bolt 474, extends through each of the tabs 472. Each fastener 474 is received by a fastener or nut, shown as barrel clip 476, that is coupled to the seat mount 368. The seat mount 368 defines two pairs of apertures or passages, shown as lateral slots 478, that extend vertically through the seat mount 368. Within each pair of lateral slots 478, the lateral slots 478 are longitudinally offset from one another, such that the seat mount 368 forms a strip of material between the lateral slots 478. The barrel clip 476 is inserted through the lateral slots 478 and wraps around the strip of material, coupling the barrel clip 476 to the seat mount 368 and limiting rotation of the barrel clip 476.

To hold, retain, or fix the bed 200 in the use position, the bed 200 is lowered until the tabs 472 rest upon the seat frame 360. The tabs 472 may contact the seat mount 368 directly, or the rear cover mat 380 may extend between the seat mount 368 and the tabs 472. The bed mounting bolts 474 are inserted through the tabs 472 and into the barrel clips 476. The bed mounting bolts 474 are tightened into threaded engagement with the barrel clips 476 while the shapes of the lateral slots 478 prevent the barrel clips 476 from rotating. Accordingly, the bed mounting bolts 474 fixedly couple the front end of the bed 200 to the seat mount 368. To reconfigure the vehicle 10 to again permit movement of the bed 200, the bed mounting bolts 474 may be unscrewed and removed from the barrel clips 476.

Beneficially, the bed mount 470 and the bed mounting bolts 474 permit a user to control whether the bed 200 is permitted to tip toward the dumping position or forced to remain in the use position. Additionally, fastening the bed 200 to the seat frame 360 may distribute the load of the bed 200 across a greater portion of the frame 12, increasing the load capacity of the bed 200. In some embodiments, the bed actuator 204 is omitted, and position of the bed 200 is manually controlled by adding or removing the bed mounting bolts 474. In other embodiments, the vehicle 10 utilizes both the bed actuator 204 and the bed mounting bolts 474 to control the bed 200. By way of example, the bed actuator 204 may be used to reposition the bed 200 after the bed mounting bolts 474 have been removed.

Referring to FIGS. 18, 19, and 31, the vehicle 10 includes a mount or support, shown as fuel tank mounting bracket 490. The fuel tank mounting bracket 490 is fixedly coupled to the cross member 326c and extends upward from the cross member 326c along an inward side of the fuel tank 242. In some embodiments, the floor pan 374 defines a cutout 376 for the fuel tank mounting bracket 490, such that the fuel tank mounting bracket 490 extends through the floor pan 374 to reach the cross member 326c. The fuel tank mounting bracket 490 is positioned forward of the uprights 342. The fuel tank 242 includes a protrusion or tab, shown as mounting flange 492, that extends laterally inward from the inward side of the fuel tank 242. The mounting flange 492 rests atop the fuel tank mounting bracket 490, such that the fuel tank mounting bracket 490 supports the fuel tank 242 and couples the fuel tank 242 to the frame 12. In some embodiments, one or more fasteners fixedly couple the mounting flange 492 to the fuel tank mounting bracket 490.

### Battery Pack

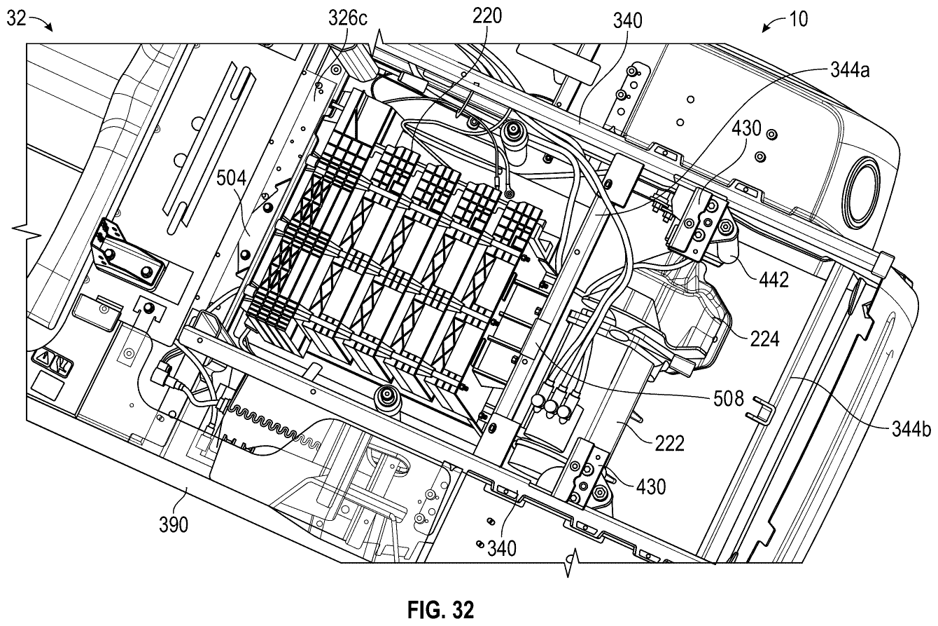

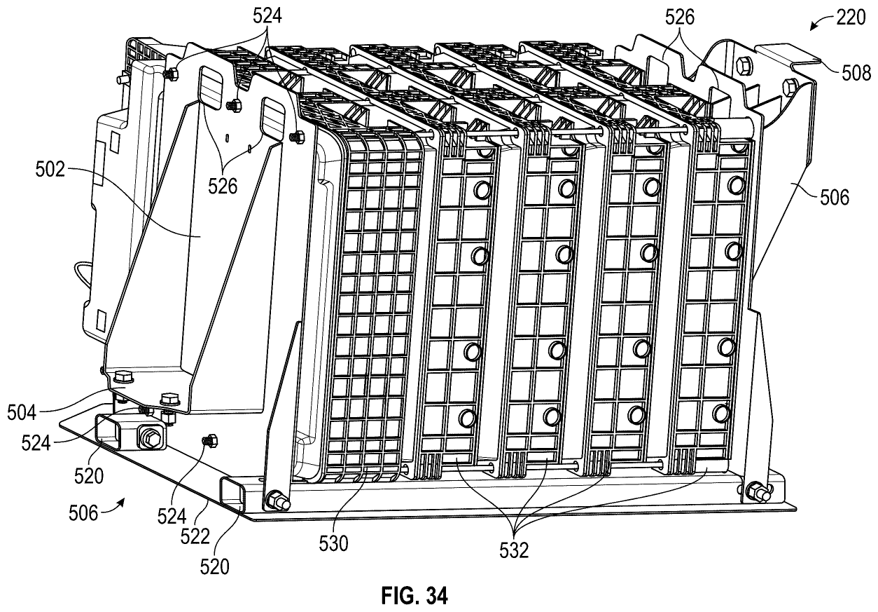

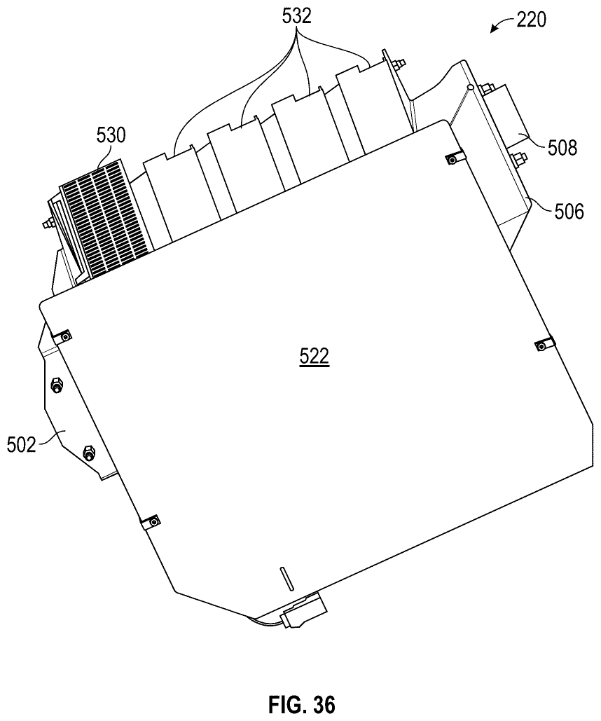

Referring to FIGS. 32-36, the battery pack 220 is shown according to an exemplary embodiment. The battery pack 220 may be fixedly coupled to the frame 12, such that the battery pack 220 has a fixed orientation relative to the frame 12. As referred to herein, a longitudinal direction, a lateral direction, and a vertical direction of the battery pack 220 match the corresponding longitudinal direction, lateral direction, and vertical direction described with respect to the vehicle 10. In some embodiments, the battery pack 220 is removably coupled to the frame 12 (e.g., for replacement or maintenance).

The battery pack 220 includes a frame assembly or subframe, shown as battery frame 500. The battery frame 500 is configured to support the other components of the battery pack 220. The battery frame 500 may facilitate coupling the battery pack 220 to the frame 12 and transporting the battery pack 220. In some embodiments, the battery pack 220 provides sufficient structure to support the components of the battery pack 220 while the battery pack 220 is removed from the frame 12.

The battery frame 500 includes a first vertical bracket, end bracket, or end cap, shown as front bracket 502. The front bracket 502 is positioned at a front end of the battery frame 500. The front bracket 502 extends substantially vertically and laterally (e.g., extends perpendicular to a longitudinal axis). The front bracket 502 includes a flange, tab, or support, shown as mounting flange 504, that extends forward from the front bracket 502. The mounting flange 504 has a bottom surface that extends substantially horizontally.

The battery frame 500 includes a second vertical bracket, end bracket, or end cap, shown as rear bracket 506. The rear bracket 506 is positioned at a rear end of the battery frame 500. The rear bracket 506 extends substantially vertically and laterally (e.g., extends perpendicular to a longitudinal axis). The rear bracket 506 may extend substantially parallel to the front bracket 502. The rear bracket 506 includes a flange, tab, or support, shown as mounting flange 508, that extends rearward from the rear bracket 506. The mounting flange 508 has a bottom surface that extends substantially horizontally.

As shown in FIG. 32, the mounting flange 504 rests atop the cross member 326c to support the battery pack 220 and couple the battery pack 220 to the frame 12. The mounting flange 508 rests atop the cross member 344a to support the battery pack 220 and couple the battery pack 220 to the frame 12. The cross member 344a is positioned above the cross member 326c. Accordingly, the mounting flange 508 is vertically offset above the mounting flange 504 to hold the battery pack 220 level when coupled to the frame 12.

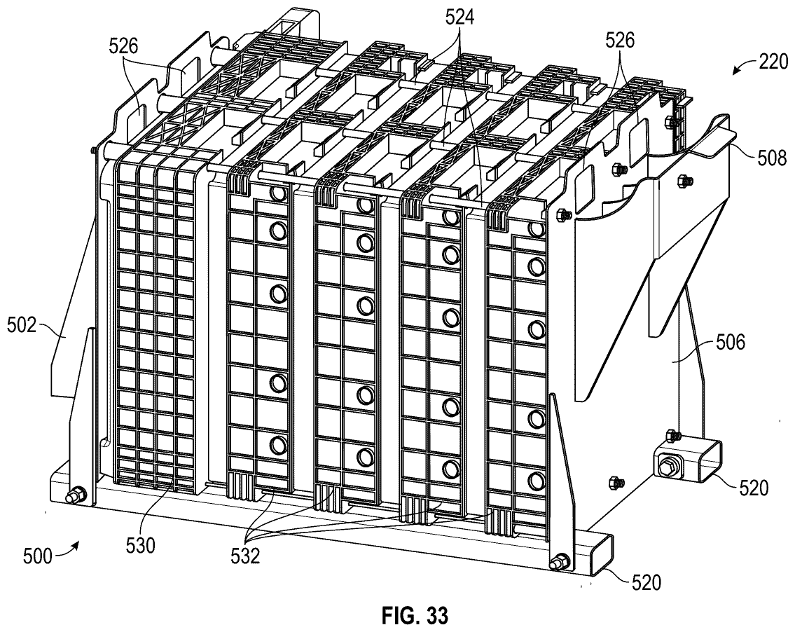

Referring to FIGS. 33-36, the battery frame 500 further includes a pair of longitudinal frame members, tubular members, or frame rails, shown as battery frame tubes 520. The battery frame tubes 520 extend longitudinally from the front end of the battery frame 500 to the rear end of the battery frame 500. The battery frame tubes 520 are laterally offset from one another and occupy a common horizontal plane. The battery frame tubes 520 extend beneath the front bracket 502 and the rear bracket 506. The front bracket 502 and the rear bracket 506 are each fixedly coupled to both of the battery frame tubes 520.

The battery frame 500 further includes a horizontal member or flat member, shown as base plate 522. The base plate 522 extends substantially horizontally along bottom surfaces of the battery frame tubes 520. The plate 522 is fixedly coupled to both of the battery frame tubes 520. The base plate 522 may improve the stiffness of the battery frame 500 and provide a flat surface to engage a ground surface (e.g., when setting the battery pack 220 onto the ground).

A series of longitudinal rods, shown as threaded rods 524, extend longitudinally along the battery frame 500. The threaded rods 524 each extend parallel to one another. Each threaded rod 524 extends through the front bracket 502 and the rear bracket 506. Fasteners (e.g., nuts) may be added to the ends of the threaded rods 524 to hold the threaded rods 524 in place relative to the battery frame 500. As shown, the battery pack 220 includes six total threaded rods 524. Three of the threaded rods 524 are arranged in a first horizontal row, and three more of the threaded rods 524 are arranged in a second horizontal row below the first horizontal row. In other embodiments, the battery pack 220 includes more or fewer threaded rods 524.

The front bracket 502 and the rear bracket 506 each define a series of apertures or passages, shown as lift points 526. The lift points 526 extend longitudinally through the front bracket 502 and the rear bracket 506. The lift points 526 may provide interface points for a lift device, such as a crane or hoist, to lift or raise the battery pack 220. By way of example, a hook may be engaged with each of the lift points 526, and the hooks may be connected to a crane through a series of chains. The lift points 526 be beneficial for manipulating the battery pack 220 due to the large weight of the battery pack 220.

The battery pack 220 includes a series of energy storage devices or battery modules, shown as front module 530 and rear modules 532. The front module 530 and the rear modules 532 are each arranged such that the smallest dimension of the module extends longitudinally. By way of example, the front module 530 has a height extending vertically, a width extending laterally, and a thickness extending longitudinally. The thickness of the front module 530 is smaller than the height and the width, such that the front module 530 extends laterally and vertically. The rear modules 532 each have a similar arrangement.

The front module 530 and the rear modules 532 are stacked longitudinally between the

front bracket 502 and the rear bracket 506. Specifically, the front module 530 abuts a rear side of the front bracket 502. A front side of one of the rear modules 532 abuts a rear side of the front module 530. The other of the rear modules 532 are arranged with the front side of one rear module 532 engaging the rear side of another rear module 532. The rear side of the last rear modules 532 engages the front side of the rear bracket 506.

The front module 530 and the rear modules 532 are fixedly coupled to the battery frame 500 by the threaded rods 524. As shown, each of the front module 530 and the rear modules 532 includes a housing defining a series of longitudinal passages that receive the threaded rods 524. Each of the threaded rods 524 extends through each of the front module 530 and the rear modules 532. The threaded rods 524 may be tightened (e.g., the nuts on the threaded rods 524 are tightened) to compress the front module 530 and the rear modules 532 between the front bracket 502 and the rear bracket 506, fixedly coupling the front module 530 and the rear modules 532 to the battery frame 500. Additionally, the threaded rods 524 act in shear to resist lateral and vertical movement of the front module 530 and the rear modules 532.

As shown, the battery pack 220 includes one front module 530 and four of the rear modules 532 (e.g., such that the battery pack 220 forms a quintuple battery pack). In other embodiments, the battery pack 220 includes more or fewer of the rear modules 532 (e.g., one rear module 532, two rear modules 532, three rear modules 532, five rear modules 532, etc.). Beneficially, the battery frame 500 may be scaled to accommodate a different number of batteries by increasing or decreasing the lengths of the battery frame tubes 520 and the threaded rods 524.

The construction of the battery pack 220 permits a large number of cell modules to be coupled to one another, increasing the battery capacity available from a single battery pack. The frame 12 may be elongated to accommodate the increased length of the bed 200 (e.g., a 6 foot bed). The increased length of the frame 12 may facilitate placement of additional stacked cell modules within the battery pack 220 while still fitting within the frame 12. In some embodiments, the battery pack 220 is capable of powering the vehicle 10 to drive at least about 85 miles (e.g., at least 76.5 miles, at least 85 miles, at least 93.5 miles, etc.) without having to recharge the battery pack 220. In some embodiments, the battery pack 220 is capable of powering the vehicle 10 to drive for at least about 80 hours (e.g., at least 72 hours, at least 80 hours, at least 88 hours, etc.).

The front module 530 is different from the rear modules 532. The front module 530 may have different exterior packaging (e.g., a different shape and/or size) than the rear modules 532. As shown, the front module 530 and the rear modules 532 are each rectangular and have similar heights and widths. However, the thickness of the front module 530 (e.g., measured longitudinally) is greater than the thickness of each rear module 532. The front module 530 may have a different battery chemistry (e.g., may utilize different chemicals) than the rear modules 532. By way of example, the front module 530 may be a composite module (e.g., including battery cells using a composite material, such as carbon fiber), whereas the rear modules 532 may be cell modules (e.g., utilizing lithium-ion polymer battery cells or nickel-cadmium battery cells).

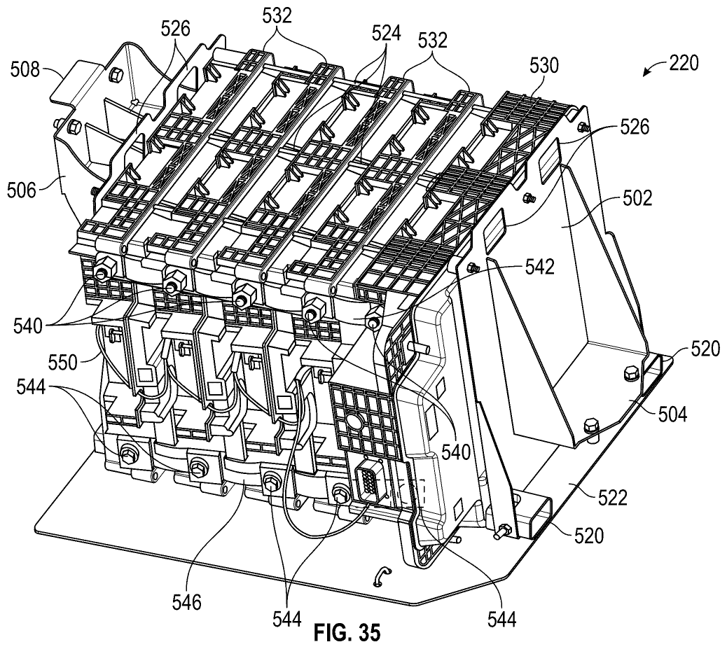

Referring to FIG. 35, each of the front module 530 and the rear modules 532 includes an electrical connector or contact, shown as positive stud 540, along a laterally-facing side of the battery pack 220. The positive studs 540 may each be electrically coupled to an anode of the corresponding battery module, such that the positive studs 540 are positively charged. The positive stud 540 may each be threaded to engage with a corresponding fastener. As shown, a first bus bar or electrical conductor, shown as positive bus bar 542, extends longitudinally along the battery pack 220 and is fastened to each of the positive studs 540. Accordingly, the positive bus bar 542 electrically couples the positive studs 540 to one another. In some embodiments, the positive studs 540 are positioned at a common height above the base plate 522, such that the positive bus bar 542 is straight, continuous, and horizontal.

Referring still to FIG. 35, each of the front module 530 and the rear modules 532 includes an electrical connector or contact, shown as negative stud 544, along a laterally-facing side of the battery pack 220. The negative studs 544 may each be electrically coupled to a cathode of the corresponding battery module, such that the negative studs 544 are negatively charged. The negative studs 544 may each be threaded to engage with a corresponding fastener. As shown, a second bus bar or electrical conductor, shown as negative bus bar 546, extends longitudinally along the battery pack 220 and is fastened to each of the negative studs 544. Accordingly, the negative bus bar 546 electrically couples the negative studs 544 to one another. In some embodiments, the negative studs 544 are positioned at a common height above the base plate 522, such that the negative bus bar 546 is straight, continuous, and horizontal.

Together, the positive bus bar 542 and the negative bus bar 546 electrically couple the front module 530 and the rear modules 532 in parallel. The parallel connections of the front module 530 and the rear modules 532 increase the available range of the vehicle 10 relative to a single module. The positive bus bar 542 and the negative bus bar 546 may provide an electrical connection point through which the battery pack 220 may be electrically coupled to the vehicle 10.

Referring still to FIG. 35, the battery pack 220 includes a coupler, shown as communication cable 550, that operatively couples the front module 530 and the rear modules 532. The front module 530 and the rear modules 532 may each include a corresponding controller (e.g., a battery management system). The communication cable 550 may place the controllers in data communication with one another. As shown, the communication cable 550 extends in series between each of the front module 530 and the rear modules 532. The communication cable 550 may be operatively coupled to the vehicle 10 to facilitate communication between the controllers and a controller of the 10 (e.g., the vehicle control system 100).

### Bed With Turntable

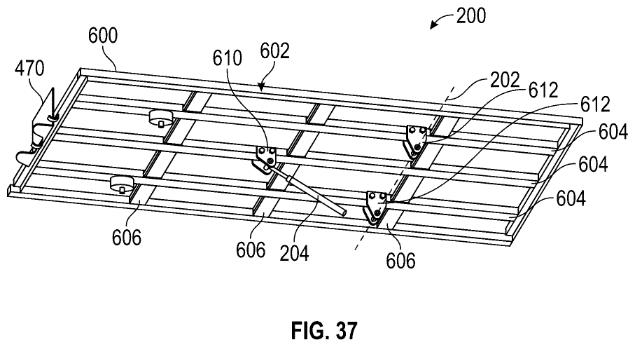

Referring to FIG. 37, the bed 200 is shown according to an exemplary embodiment. The bed 200 includes a support section or top surface section, shown as top assembly 600, and a support or frame assembly, shown as bed frame 602. The top assembly 600 defines a top surface of the bed 200 that engages and supports the payload of the bed 200. The top assembly 600 is positioned atop the bed frame 602 and coupled to the bed frame 602. The bed frame 602 provides an underlying support structure for the top assembly 600 and couples the top assembly 600 to the frame 12.

As shown in FIG. 37, the bed frame 602 includes a series of longitudinally-extending frame members, shown as longitudinal members 604, and a series of laterally-extending frame members, shown as lateral members 606. The longitudinal members 604 and the lateral members 606 are fixedly coupled to one another to form the bed frame 602. The longitudinal members 604 and the lateral members 606 may occupy a common plane.

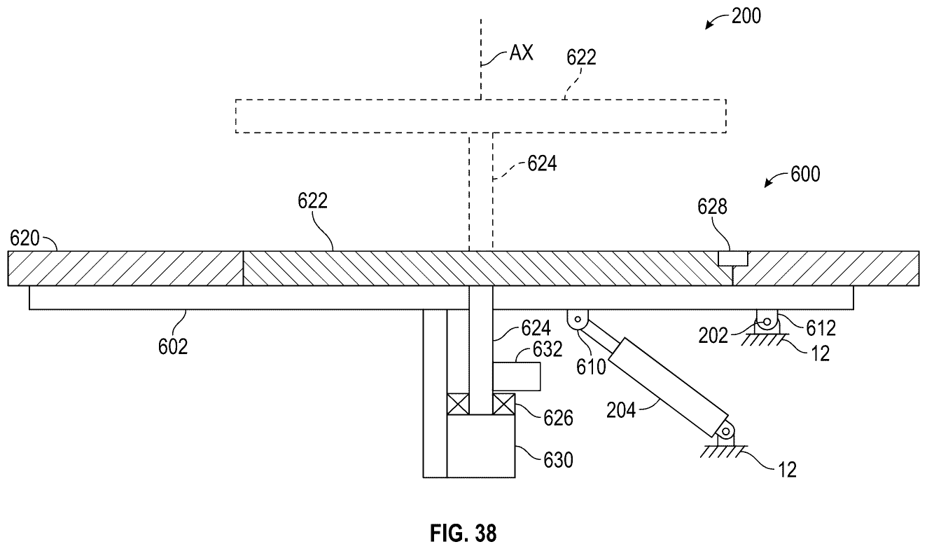

A first mounting bracket or clevis, shown as actuator mount 610, is coupled to a longitudinal members 604 that is laterally centered on the bed frame 602. The actuator mount 610 pivotably couples an upper end of the bed actuator 204 to the bed frame 602. A pair of second mounting brackets or clevises, shown as pivot mounts 612, are coupled to two other longitudinal members 604. The pivot mounts 612 are laterally offset from one another and offset rearward of the actuator mount 610. Each of the pivot mounts 612 is pivotably coupled to one of the bed pivots 346, such that the pivot mounts 612 pivotably couple the bed 200 to the frame 12. Referring to FIG. 38, a configuration of the bed 200 is shown according to an exemplary

embodiment. The bed 200 of FIG. 38 may be substantially similar to the bed 200 of FIG. 37, except as otherwise specified herein. In the bed 200 of FIG. 38, the top assembly 600 includes both a fixed top panel or top panel assembly, shown as stationary portion 620, and a movable top panel, top panel assembly, work platform, work table, rotating portion, raising portion, lowering portion, or raising and lowering portion, shown as turntable 622. The rotating portion 622 is movable relative to the stationary portion 620, providing a movable work surface that is beneficial in certain scenarios.

As shown in FIG. 38, the turntable 622 is coupled to a support structure, shown as support shaft 624. The support shaft 624 extends downward from the turntable 622 along a vertical axis, shown as axis AX, and is received by a rotatable or sliding member (e.g., a bearing, a bushing, etc.), shown as bearing 626. The bearing 626 is coupled to the bed frame 602 and centered along the axis AX.

The bearing 626 supports the support shaft 624 and the turntable 622 while permitting desirable movement of the support shaft 624 and the turntable 622. In some embodiments, the bearing 626 is permits free rotation of the turntable 622 and the support shaft 624 about the axis AX. In some embodiments, the bearing 626 permits axial movement (e.g., vertical translation) of the support shaft 624 and the turntable 622 along the axis AX. In some embodiments, the bearing 626 permits both rotation and axial movement.

The bed 200 further includes a locking mechanism, brake, latch, or catch, shown as lock 628. The lock 628 includes a first section coupled to the stationary portion 620 and a second section coupled to the turntable 622. The lock 628 may be selectively engage to limit (e.g., prevent) movement of the turntable 622 relative to the stationary portion 620. By way of example, the lock 628 may include a pin or brake that selectively engages the turntable 622 to limit movement of the turntable 622. In some embodiments, the lock 628 limits rotation of the turntable 622 about the axis AX. By way of example, the lock 628 may hold the turntable 622 in a desired orientation. In some embodiments, the lock 628 limits axial movement of the turntable 622 along the axis AX. By way of example, the lock 628 may hold the turntable 622 at a desired height. In some embodiments, the lock 628 is manually controlled (e.g., by an operator moving a switch or knob on the lock 628). In some embodiments, the lock 628 is electronically controlled (e.g., by the vehicle control system 100). By way of example, an operator may control the lock 628 through the operator controls 40 while seated in the occupant seating area 30.

The bed 200 further includes an actuator (e.g., a linear actuator, a lift actuator, etc.), shown as turntable lift actuator 630, coupled to the bed frame 602. The turntable lift actuator 630 is configured to apply an upward force to lift the turntable 622 along the axis AX relative to the stationary portion 620. In some embodiments, the turntable lift actuator 630 is further configured to apply a downward force to lower the turntable 622. In other embodiments, gravity is used to lower the turntable 622. The turntable lift actuator 630 may apply the upward and downward force on the turntable 622 through the support shaft 624. By way of example, the support shaft 624 may be a shaft of a linear actuator (e.g., a hydraulic cylinder, an electric linear actuator, etc.).

The bed 200 further includes an actuator (e.g., a motor, a rotation actuator, etc.), shown as turntable rotation actuator 632, coupled to the bed frame 602. The turntable rotation actuator 632 is configured to apply a torque to rotate the turntable 622 about the axis AX. The turntable rotation actuator 632 may apply the torque on the turntable 622 through the support shaft 624. By way of example, the support shaft 624 may be coupled to a gear in meshing engagement with an output of the turntable rotation actuator 632 (e.g., an electric motor, a hydraulic motor, etc.).

As shown in FIG. 2, the turntable lift actuator 630 and the turntable rotation actuator 632 are operatively coupled to the vehicle control system 100, such that the vehicle control system 100 may control operation of the turntable lift actuator 630 and the turntable rotation actuator 632. The vehicle control system 100 may operate the turntable lift actuator 630 and/or the turntable rotation actuator 632 based on commands received from an operator through the operator controls 40. By way of example, the operator controls 40 may include (e.g., as part of the operator interface 48), buttons for issuing raise, lower, clockwise rotation, and counterclockwise rotation commands. In other embodiments, the turntable lift actuator 630 and/or the turntable rotation actuator 632 are manually operated (e.g., through a foot pump or crank).

As shown in FIG. 4, the operator controls 40 may be positioned within the body 20, such that an operator may control the turntable lift actuator 630 and the turntable rotation actuator 632 while seated in the occupant seating area 30. Beneficially, this may require the operator to move away from the turntable 622, preventing contact between the operator and the turntable 622 while the turntable 622 is moving. In other embodiments, the turntable lift actuator 630 and/or the turntable rotation actuator 632 are operated from elsewhere (e.g., buttons of the operator interface 48 coupled to the bed 200).

Beneficially, the rotation of the turntable 622 may facilitate movement of items stored on the bed 200. A user may place several items onto the turntable 622 (e.g., multiple of the same item, different items, etc.). The user may rotate the turntable 622 to facilitate access to items that would otherwise be farther away from their current location. By way of example, a catering company may place several trays of food and/or drinks onto the turntable 622 for transport to a venue where the food will be served. The user may unload the trays closest to them first, minimizing their reach required to access the trays. The user may then rotate the turntable 622 to place other trays in close proximity to themselves. This process may be repeated until all of the trays are unloaded without ever requiring the user to reach a significant distance.

By way of another example, a construction worker may place a variety of different tools on the turntable 622. When a specific tool is desired, the worker may rotate the turntable 622 until the desired tool is located and positioned close to them. This prevents the worker from having to reach an uncomfortable distance to access tools that would otherwise be near the back of the bed 200.

As shown in FIG. 38, the turntable 622 may be movable between a lowered position (e.g., shown in solid lines in FIG. 38) and a raised position (e.g., shown in dashed lines in FIG. 38). In the lowered position, a top surface of the turntable 622 may be flush with (e.g., coplanar with) a top surface of the stationary portion 620. In the lowered position, the top surfaces of the stationary portion 620 and the turntable 622 function as one continuous, large surface. The lowered position may be useful for carrying large loads that require the entire size of the bed 200. In the lowered position, the turntable 622 may rest on the bed frame 602, such that the bed frame 602 supports at least part of the load on the turntable 622.

In the raised position, the top surface of the turntable 622 is positioned above the top surface of the stationary portion 620. The raised position may facilitate using the turntable 622 as a workbench or worktable. This turntable 622 may eliminate the need to bring a separate worktable to a jobsite. A user may place one or more items of interest on the turntable 622. Any items placed on the turntable 622 may be raised with the turntable 622, moving the items to a desired height. The desired height may be more ergonomic for certain tasks than the height of the lowered position. By way of example, the raised position may permit a user to interact with the items on the turntable 622 without having to bend over.

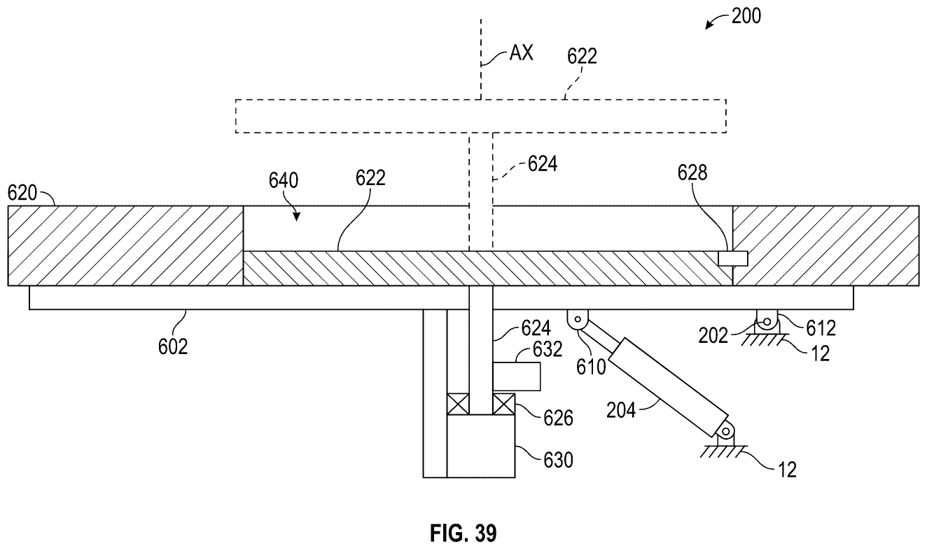

Referring to FIG. 39, the bed 200 is shown according to an alternative embodiment. The bed 200 of FIG. 39 may be substantially similar to the bed 200 of FIG. 38 except as otherwise specified herein. In the bed 200 of FIG. 39, a vertical thickness of the stationary portion 620 is greater than a vertical thickness of the turntable 622. Accordingly, the bed 200 is further repositionable to a recessed position (shown in solid lines in FIG. 39). In the recessed position, the top surface of the turntable 622 is offset below the top surface of the stationary portion 620. Accordingly, a recess 640 is formed between the top surface of turntable 622 and the sides of the stationary portion 620. The recess 640 extends downward from the top surface of the stationary portion 620. Accordingly, the top surface of the turntable 622 is recessed below the top surface of the stationary portion 620.

Beneficially, the recessed position may facilitate securely storing items within the recess 640. When in the lowered position, items positioned on the turntable 622 may slide off of the turntable 622 (e.g., when braking, accelerating, or turning the vehicle 10). When in the recessed position, the stationary portion 620 extends above the turntable 622 and stops any items from sliding off of the turntable 622. In other embodiments, the turntable 622 includes a raised ring or lip that extends above the top surface of the turntable 622 to prevent items sliding off of the turntable 622.

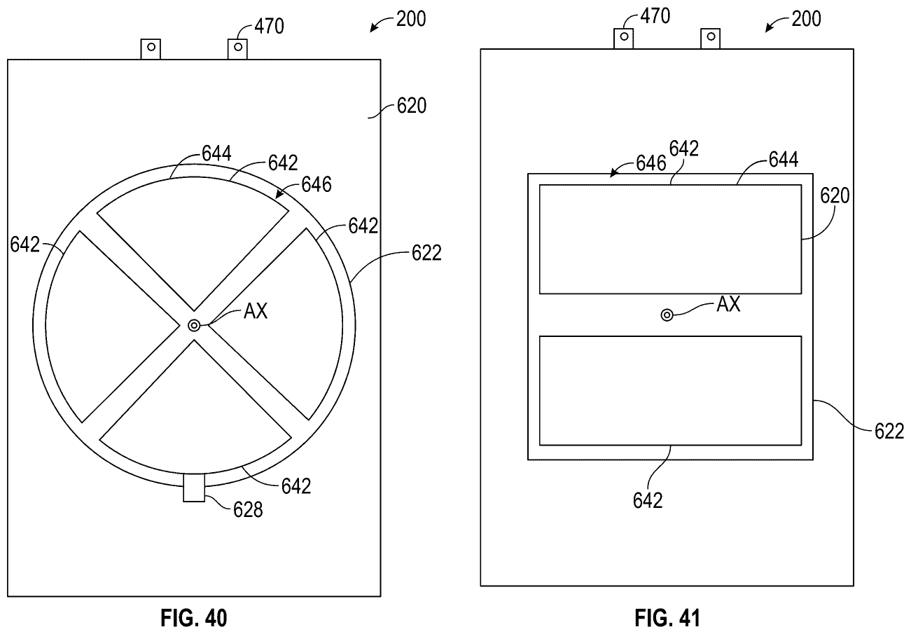

Referring to FIGS. 40-42, turntable 622 of different shapes are shown. The turntables 622 of FIGS. 40-41 may represent either of the turntables 622 of FIGS. 38 and 39. Accordingly, any description with respect to the beds 200 of FIGS. 38 and 39 may also apply to the beds 200 of FIGS. 40-42.

In the embodiment of FIG. 40, the turntable 622 is circular, and the axis AX passes through a center of the turntable 622. The center of the turntable 622 may represent a geometric center of the turntable 622 as viewed from above (e.g., a centroid of a footprint of the turntable 622). The stationary portion 620 defines a circular cutout that receives the turntable 622, such that the stationary portion 620 surrounds the turntable 622. Due to the circular shape of the turntable 622 and the centered position of the axis AX, the turntable 622 may be rotated freely (e.g., a full 360 degrees) without the turntable 622 contacting the stationary portion 620. Accordingly, the lock 628 may be used to maintain a desired rotational position of the 622.

In the embodiment of FIG. 41, the turntable 622 is square, and the axis AX passes through a center of the turntable 622. The stationary portion 620 defines a square cutout that receives the turntable 622, such that the stationary portion 620 surrounds the turntable 622. Due to the square shape of the turntable 622 and the centered position of the axis AX, the turntable 622 may be rotated to four different rotational positions in which the turntable 622 may be received within the stationary portion 620. Other positions may cause the stationary portion 620 to contact the turntable 622, preventing the turntable 622 from being retracted. Due to contact between the turntable 622 and the stationary portion 620, the turntable 622 may be held in any of the four rotational positions by retracting the turntable 622 into the stationary portion 620.

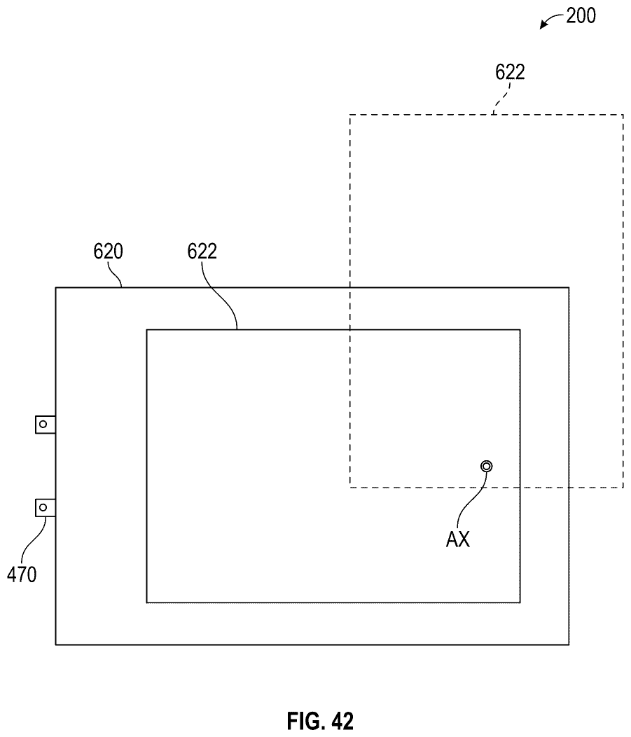

In the embodiment of FIG. 42, the turntable 622 is rectangular, and the axis AX is offset from a center of the turntable 622 (e.g., the axis AX is eccentric). The stationary portion 620 defines a rectangular cutout that receives the turntable 622, such that the stationary portion 620 surrounds the turntable 622. Due to the eccentric position of the axis AX, the turntable 622 may be rotated to only one rotational position in which the turntable 622 may be received within the stationary portion 620. Other positions may cause the stationary portion 620 to rotate outward and hang over the sides of the bed 200. Such a position is shown in dashed lines in FIG. 42, in which the turntable 622 hangs over a right side and a rear side of the stationary portion 620 of the bed 200.

The eccentric configuration of the turntable 622 may be advantageous when performing certain tasks. By way of example, by overhanging a side of the bed with the turntable 622, a user may access the turntable 622 directly without having to reach over the stationary portion 620. Additionally, the turntable 622 may be placed over objects in the environment. By way of example, a chair may be placed beneath the turntable 622, permitting a user to use the turntable 622 as a desk.

Referring to FIG. 40, the bed 200 further includes a series of storage areas, containers, or bins, shown as containers 642, coupled to the turntable 622. Each container 642 includes a cover, shown as lid 644, and defines a recess, shown a storage volume 646. The storage volume 646 extends downward from (e.g., is recessed inward from) the top surface of the turntable 622, such that the storage volume 646 is open from above (e.g., defines a top access aperture).

The lid 644 is repositionable between a closed position (shown in FIG. 40) and an open position. In the closed position, the lid 644 extends across the aperture of the storage volume 646, limiting (e.g., preventing) access to the storage volume 646. In the closed position, the lid 644 may be flush with or recessed below the top surface of the turntable 622. In the open position, the lid 644 is moved away from the storage volume 646, uncovering the storage volume 646 and permitting access to the storage volume 646 from above. By way of example, the lid 644 may be pivotably coupled to the turntable 622 (e.g., by a hinge) to permit repositioning the lid 644.

As shown in FIG. 40, the bed 200 includes four containers 642, each radially offset from the axis AX and each rotationally offset from one another. As shown, the containers 642 are evenly spaced and wedge-shaped, such that the containers 642 are rotationally offset from one another by 90 degrees. Accordingly, a user standing next to the bed 200 (e.g., along a right side of the bed 200) may be able to easily access one of the containers 642. If the user desires to access a different one of the containers 642, the user may rotate the turntable 622 (e.g., using the turntable rotation actuator 632) to move the other containers 642 toward them.

The containers 642 may be used for organized, under-bed storage for storing material, tools, equipment, or other items. By way of example, each of the containers 642 may function as a toolbox. A user may store a different type of tool in each container 642 (e.g., divided based on the task). The user may select the container 642 containing a desired tool and rotate the turntable 622 to access the container 642.

FIG. 41 illustrates another embodiment of the bed 200 including containers 642. As shown, the bed 200 includes two containers 642 positioned opposite one another on the square turntable 622. The containers 642 are rectangular and rotationally offset from one another by 180 degrees.

As utilized herein with respect to numerical ranges, the terms “approximately,” “about,”“substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, and the vehicle control system 100 as shown in the various exemplary embodiments is illustrative only. Additionally, any element disclosed in one embodiment may be incorporated or utilized with any other embodiment disclosed herein.

1. A utility vehicle comprising:
a chassis defining a longitudinal axis;
a tractive element coupled to the chassis;
a prime mover configured to drive the tractive element to propel the utility vehicle;
a seat assembly supported by the chassis and configured to support an operator, the seat assembly including a seat frame and a seat supported by the seat frame, the seat frame defining a storage compartment beneath the seat;
a bed positioned rearward of the seat, wherein the bed is pivotable relative to the chassis between a first position and a second position; and
at least one of (a) an actuator configured to move the bed between the first position and the second position or (b) a fastener removably coupled to the seat frame and configured to limit movement of the bed from the first position toward the second position;
wherein the bed is configured to support a load of at least about 1,200 pounds; and
wherein the bed has a bed length extending at least about 6 feet along the longitudinal axis.

2. The utility vehicle of claim 1, wherein the prime mover includes an electric motor, further comprising a battery pack coupled to the chassis and configured to supply electrical energy to the electric motor, wherein the battery pack is positioned rearward of the storage compartment and beneath the bed.

3. The utility vehicle of claim 2, wherein the battery pack is positioned rearward of the seat assembly.

4. The utility vehicle of claim 2, wherein the battery pack includes a first battery module and a second battery module electrically coupled to one another, wherein the first battery module is longitudinally offset from the second battery module.

5. The utility vehicle of claim 2, wherein the electric motor is positioned rearward of the storage compartment and beneath the bed.

6. The utility vehicle of claim 5, wherein the battery pack positioned between the electric motor and the storage compartment.

7. The utility vehicle of claim 1, wherein the prime mover includes an engine, further comprising:
a fuel tank coupled to the chassis and configured to supply fuel to the engine; and
at least one of (a) an air intake coupled to a rear side of the seat frame and configured to supply air to the engine or (b) a carbon canister coupled to the rear side of the seat frame and configured to capture a contaminant released by the fuel tank.

8. The utility vehicle of claim 7, further comprising the air intake coupled to the rear side of the seat frame and configured to supply the air to the engine.

9. The utility vehicle of claim 7, further comprising the carbon canister coupled to the rear side of the seat frame and configured to capture the contaminant released by the fuel tank.

10. The utility vehicle of claim 7, further comprising both (a) the air intake coupled to the rear side of the seat frame and configured to supply the air to the engine and (b) the carbon canister coupled to the rear side of the seat frame and configured to capture the contaminant released by the fuel tank.

11. The utility vehicle of claim 7, wherein the fuel tank includes a deep portion and a shallow portion, and wherein the chassis includes a splash plate having a raised portion that extends beneath the shallow portion of the fuel tank and a lowered portion that extends beneath the deep portion of the fuel tank.

12. The utility vehicle of claim 11, wherein the chassis includes a pair of frame rails that extend longitudinally along the longitudinal axis and are laterally offset from one another, wherein the splash plate extends laterally outward of the pair of frame rails.

13. The utility vehicle of claim 7, wherein the engine is positioned rearward of the storage compartment and beneath the bed.

14. The utility vehicle of claim 1, wherein the prime mover includes an engine, further comprising a fuel tank coupled to the chassis and configured to supply fuel to the engine, wherein the engine and the fuel tank are positioned rearward of the storage compartment and below the bed.

15. The utility vehicle of claim 1, further comprising the actuator configured to move the bed between the first position and the second position, and wherein the actuator is configured to raise a front end of the bed to move the bed from the first position to the second position.

16. The utility vehicle of claim 1, further comprising the fastener removably coupled to the seat frame.

17. The utility vehicle of claim 1, wherein the seat includes a seat back and a seat bottom, and wherein the seat bottom is repositionable to permit access to the storage compartment.

18. The utility vehicle of claim 1, wherein the bed is constructed primarily from aluminum.

19. A utility vehicle comprising:
a chassis extending longitudinally;
a tractive element coupled to the chassis;
an electric motor configured to drive the tractive element to propel the utility vehicle;
a battery pack coupled to the chassis and positioned forward of the electric motor, the battery pack configured to supply electrical energy to the electric motor, the battery pack including a first battery module and a second battery module longitudinally offset from the first battery module;
a seat assembly supported by the chassis, the seat assembly including a seat frame and a seat supported by the seat frame, the seat frame defining a storage compartment beneath the seat, the seat including a seat bottom that is repositionable to permit access to the storage compartment; and
a bed positioned rearward of the seat and coupled to the chassis, the bed pivotable relative to the chassis;
wherein the battery pack and the electric motor are both positioned beneath the bed and rearward of the storage compartment; and
wherein the bed is configured to support a load of at least about 1,200 pounds, wherein the bed has a bed length extending longitudinally, and wherein the bed length is at least about 6 feet.

20. A utility vehicle comprising:
a chassis including:
a first frame rail and a second frame rail extending longitudinally and laterally offset from one another;
a splash plate fixedly coupled to the first frame rail and extending laterally away from the second frame rail; and
a seat frame fixedly coupled to the first frame rail and the second frame rail and extending upward from the first frame rail;
a tractive element coupled to the chassis;
an engine coupled to the chassis and configured to drive the tractive element to propel the utility vehicle;
a fuel tank coupled to the chassis and configured to supply fuel to the engine, wherein the splash plate extends beneath the fuel tank;
a seat assembly supported by the chassis, the seat assembly including a seat frame and a seat supported by the seat frame, the seat frame defining a storage compartment beneath the seat, the seat including a seat bottom that is repositionable to permit access to the storage compartment;
an air intake coupled to a rear side of the seat frame and configured to supply air to the engine;
a carbon canister coupled to the rear side of the seat frame and configured to capture a contaminant released by the fuel tank; and
a bed positioned rearward of the seat and coupled to the chassis, wherein the bed is pivotable relative to the chassis between a first position and a second position;
wherein the engine and the fuel tank are positioned rearward of the storage compartment and below the bed; and
wherein the bed is configured to support a load of at least about 1,200 pounds, wherein the bed has a bed length extending longitudinally, and wherein the bed length is at least about 6 feet.
